(19) United States
(12) Patent Application Publication
(10) Pub. No.: US 2013/0324247 A1
(43) Pub. Date: Dec. 5, 2013

(54) INTERACTIVE SPORTS APPLICATIONS

(71) Applicant: Microsoft Corporation, Redmond, WA (US)

(72) Inventors: Christopher Esaki, Redmond, WA (US); David Seymour, Vancouver (CA); William Mozell, Vancouver (CA); John Bradley, Redmond, WA (US); Evan Brandt, Redmond, WA (US); Mike Christian, Redmond, WA (US); Ryan Cleven, Vancouver (CA); Ryan Crandall, Redmond, WA (US); Scott Gardner, Redmond, WA (US); Patrick Moody Grigsby, Vancouver (CA); Ashish Gupta, Redmond, WA (US); Vernon Hui, Redmond, WA (US); David Jurenka, Redmond, WA (US); Mike Mahar, Vancouver (CA); Preet Mangat, Vancouver (CA); Brian Ostergren, Redmond, WA (US); Bob Settles, Redmond, WA (US); Michael Siebert, Redmond, WA (US); Todd Stevens, Redmond, WA (US); Josh Trusz, Vancouver (CA); Ryan Wilson, Redmond, WA (US); Nathan Charley, Redmond, WA (US); Henry Watson, Redmond, WA (US); Mark Findlay, Redmond, WA (US); Adam Potratz, Redmond, WA (US)

(21) Appl. No.: 13/909,738

(22) Filed: Jun. 4, 2013

Related U.S. Application Data
(60) Provisional application No. 61/655,348, filed on Jun. 4, 2012.

(51) Int. Cl. A63F 13/00

(52) U.S. Cl. CPC A63F 13/00
USPC 463/31

(57) ABSTRACT

A system and method are disclosed for presenting an event to a user while allowing a user to make a prediction during the event, allowing the user to choose different content while viewing the event, displaying the chosen content while also displaying the event in an intelligent manner and providing a jump bar to navigate between content and/or features.

### CLAIM OF PRIORITY

The present application claims priority to U.S. Provisional Patent Application No. 61/655,348, entitled “Interactive Sports Applications,” filed Jun. 4, 2012, which application is incorporated by reference herein in its entirety.

### BACKGROUND

Gaming systems have evolved from those which provided an isolated gaming experience to networked systems providing a rich, interactive experience which may be shared in real time between friends and other gamers. With Microsoft's Xbox® video game system and Xbox Live® online service, users can now easily communicate with each other while playing to share the gaming experience.

The Xbox Live® online service also provides for users of the Xbox® video game to obtain additional content.

### SUMMARY

Embodiments of the present system relate to a gaming and media system in which a user may quickly and easily obtain additional content while viewing an event or other type of presentation on a monitor that is in communication with an entertainment console (or other computing device). In one example, a graphical user interface may include an interactive guide, referred to herein as a mini-guide, including a variety of displayed categories, or twists, from which a user may quickly and easily access and view content from a variety of diverse categories. In a further example, a graphical user interface may include a macro navigation tool, referred to herein as a jump bar, which may appear as a drop down pane including a variety of tiles for quick and easy access to a variety of different content sources.

In examples, a user may choose more than one item of content to view at the same time. In accordance with a further aspect of the present technology, items of content may be displayed using what may be referred to herein as a smart view algorithm. The smart view algorithm, or simply smart view, arranges content on a display in a way which enhances a view of the content by one or more users.

The present technology further includes a prediction application allowing a user to select an outcome from among a group of alternative outcomes, for example in a sporting content. For example, in a sporting event, a user is able to make their pick via a “picks tile” on the graphical user interface as to the ultimate outcome of a sporting event, such as for example which contestant or team will win. The prediction application also allows a user to make their pick as to the outcome of interim events, such as for example which contestant or team will be leading at the end of a quarter, period, inning, etc. Using the prediction application, a user can also make a variety of other picks relating to sporting and other events.

In one example, the present technology relates to a gaming apparatus, comprising an input system for inputting commands to the gaming apparatus; and a processor for receiving commands from the input system and generating a graphical user interface, the processor implementing any combination of one or more of: a mini-guide for displaying categories of content and lists of content associated with the categories via the graphical user interface, the content coming from a video or still content providing service, the mini-guide displaying the lists of content as a plurality of selectable graphical windows having still images or video content, input from the input system scrolling through the plurality of graphical windows of a list; a prediction software application for receiving predictions via the input system and providing feedback when it is determined whether a prediction is correct or incorrect, and providing reward points when a prediction is correct, the prediction software application presenting questions on which predictions are received, the questions relating to an event depicted in a selected graphical window from the mini-guide; and a smart screen application for arranging and sizing two or more items of content displayed on the graphical user interface based on a set of rules, the rules including positioning an item of content on a first side of the graphical user interface where the first item of content was generated from receipt of a command that is detected as coming from a location proximate the first side of the graphical user interface.

In a further example, the present technology relates to a system, comprising: an input system for inputting commands controlling content displayed on the gaming system; a processor for receiving commands from the input system and generating a graphical user interface on a display, the processor implementing a prediction software application via the graphical user interface for presenting questions customized in real time to content the user is viewing, and for receiving predictions in response to the questions via the input system; and a storage location for storing information regarding predictions received.

In another example, the present technology relates to a method of facilitating interaction with an audio/video presentation, comprising: (a) displaying a graphical user interface including a display of a first item of video content; (b) superimposing a mini-guide over the first item of content at a size and location allowing a majority of the first item of content to be viewed, the mini-guide displaying categories of content and lists of content associated with the categories via the graphical user interface, the categories being customized to the first item of content being displayed, and the lists of content being a plurality of selectable graphical windows having still images or video content; (c) receiving a selection of a graphical window from the mini-guide; and (d) displaying a second item of content from the graphical window selected in said step (c) on the graphical user interface.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIGS. 1A and 1B illustrate an example embodiment of a tracking system with a user playing a game.

FIG. 2 illustrates an example embodiment of a capture device that may be used as part of the tracking system.

FIG. 3 illustrates an example embodiment of a computing system that may be used to track motion and update an application based on the tracked motion.

FIG. 4 illustrates another example embodiment of a computing system that may be used to track motion and update an application based on the tracked motion.

FIG. 5 is a block diagram of an example of an operating environment.

FIGS. 6A-6H depict various embodiments of a guide for interacting with a video content providing service.

FIGS. 7A-7C depicts various embodiments of a jump bar for navigating to different features and content.

FIG. 8A shows one embodiment for a guide for interacting with a video content providing service, with a second video being chosen.

FIG. 8B shows a split screen mode, showing the original video and second video sharing a screen (split screen), after the second video is chosen using the guide of FIG. 8A.

FIGS. 9A-C depict various embodiments for sharing a screen between sources of content.

FIGS. 10A-J depicts screen shots displayed on a monitor that show the operation of the application that allows users to predict events in real time during an event.

FIGS. 11A-D describe details of the prediction application.

### DETAILED DESCRIPTION

The present system will now be described with reference to the attached drawings, which in general relate to a gaming and media system (or other computing device) in which a user may interact with an online service. One embodiment of interactive applications includes an interactive guide application referred to herein as a mini-guide application or mini-guide, a smart screen sharing application referred to herein as a smart view application or smart view, a navigation tool referred to herein as a jump bar application or jump bar, and a prediction application, which run on a local gaming and media system (or other computing device) and provide for interaction with a content delivery service.

A user may interact with these applications using a variety of interfaces including for example a computer having an input device such as a mouse, a gaming device having an input device such as a controller or a natural user interface (NUI). With NUI, user movements and gestures are detected, interpreted and used to control aspects of a gaming or other application.

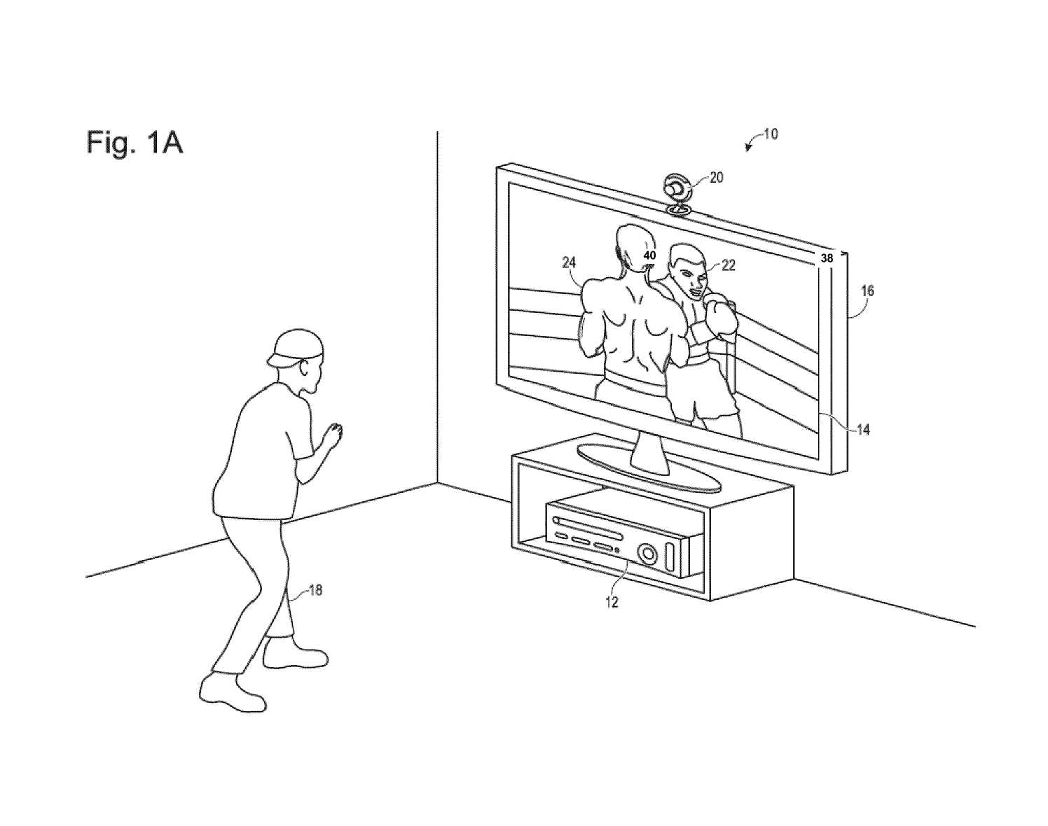

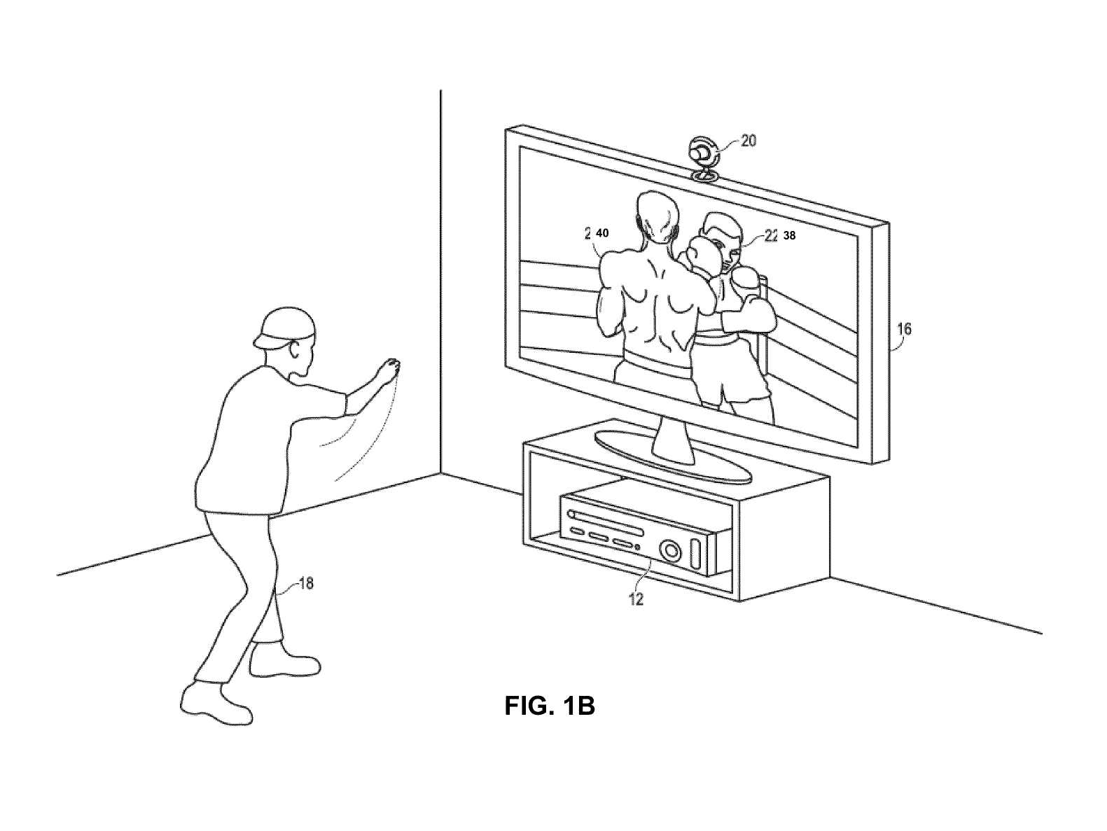

FIGS. 1A and 1B illustrate an example embodiment of a NUI system 10 with a user 18 playing a boxing game. In an example embodiment, the system 10 may be used to recognize, analyze, and/or track a human target such as the user 18 or other objects within range of tracking system 10.

As shown in FIG. 1A, tracking system 10 may include a computing system 12. The computing system 12 may be a computer, a gaming system or console, or the like. According to an example embodiment, the computing system 12 may include hardware components and/or software components such that computing system 12 may be used to execute applications such as gaming applications, non-gaming applications, or the like. In one embodiment, computing system 12 may include a processor such as a standardized processor, a specialized processor, a microprocessor, or the like that may execute instructions stored on a processor readable storage device for performing the processes described herein.

As shown in FIG. 1A, tracking system 10 may further include a capture device 20. The capture device 20 may be, for example, a camera that may be used to visually monitor one or more users, such as the user 18, such that gestures and/or movements performed by the one or more users may be captured, analyzed, and tracked to perform one or more controls or actions within the application and/or animate an avatar or on-screen character, as will be described in more detail below.

According to one embodiment, the tracking system 10 may be connected to an audiovisual device 16 such as a television, a monitor, a high-definition television (HDTV), or the like that may provide game or application visuals and/or audio to a user such as the user 18. For example, the computing system 12 may include a video adapter such as a graphics card and/or an audio adapter such as a sound card that may provide audiovisual signals associated with the game application, non-game application, or the like. The audiovisual device 16 may receive the audiovisual signals from the computing system 12 and may then output the game or application visuals and/or audio associated with the audiovisual signals to the user 18. According to one embodiment, the audiovisual device 16 may be connected to the computing system 12 via, for example, an S-Video cable, a coaxial cable, an HDMI cable, a DVI cable, a VGA cable, component video cable, or the like.

As shown in FIGS. 1A and 1B, the tracking system 10 may be used to recognize, analyze, and/or track a human target such as the user 18. For example, the user 18 may be tracked using the capture device 20 such that the gestures and/or movements of user 18 may be captured to animate an avatar or on-screen character and/or may be interpreted as controls that may be used to affect the application being executed by computer system 12. Thus, according to one embodiment, the user 18 may move his or her body to control the application and/or animate the avatar or on-screen character.

In the example depicted in FIGS. 1A and 1B, the application executing on the computing system 12 may be a boxing game that the user 18 is playing. For example, the computing system 12 may use the audiovisual device 16 to provide a visual representation of a boxing opponent 38 to the user 18. The computing system 12 may also use the audiovisual device 16 to provide a visual representation of a player avatar 40 that the user 18 may control with his or her movements. For example, as shown in FIG. 1B, the user 18 may throw a punch in physical space to cause the player avatar 40 to throw a punch in game space. Thus, according to an example embodiment, the computer system 12 and the capture device 20 recognize and analyze the punch of the user 18 in physical space such that the punch may be interpreted as a game control of the player avatar 40 in game space and/or the motion of the punch may be used to animate the player avatar 40 in game space.

Other movements by the user 18 may also be interpreted as other controls or actions and/or used to animate the player avatar, such as controls to bob, weave, shuffle, block, jab, or throw a variety of different power punches. Furthermore, some movements may be interpreted as controls that may correspond to actions other than controlling the player avatar 40. For example, in one embodiment, the player may use movements to end, pause, or save a game, select a level, view high scores, communicate with a friend, etc. According to another embodiment, the player may use movements to select the game or other application from a main user interface. Thus, in example embodiments, a full range of motion of the user 18 may be available, used, and analyzed in any suitable manner to interact with an application.

In example embodiments, the human target such as the user 18 may have an object. In such embodiments, the user of an electronic game may be holding the object such that the motions of the player and the object may be used to adjust and/or control parameters of the game. For example, the motion of a player holding a racket may be tracked and utilized for controlling an on-screen racket in an electronic sports game. In another example embodiment, the motion of a player holding an object may be tracked and utilized for controlling an on-screen weapon in an electronic combat game. Objects not held by the user can also be tracked, such as objects thrown, pushed or rolled by the user (or a different user) as well as self propelled objects. In addition to boxing, other games can also be implemented.

According to other example embodiments, the tracking system 10 may further be used to interpret target movements as operating system and/or application controls that are outside the realm of games. For example, virtually any controllable aspect of an operating system and/or application may be controlled by movements of the target such as the user 18.

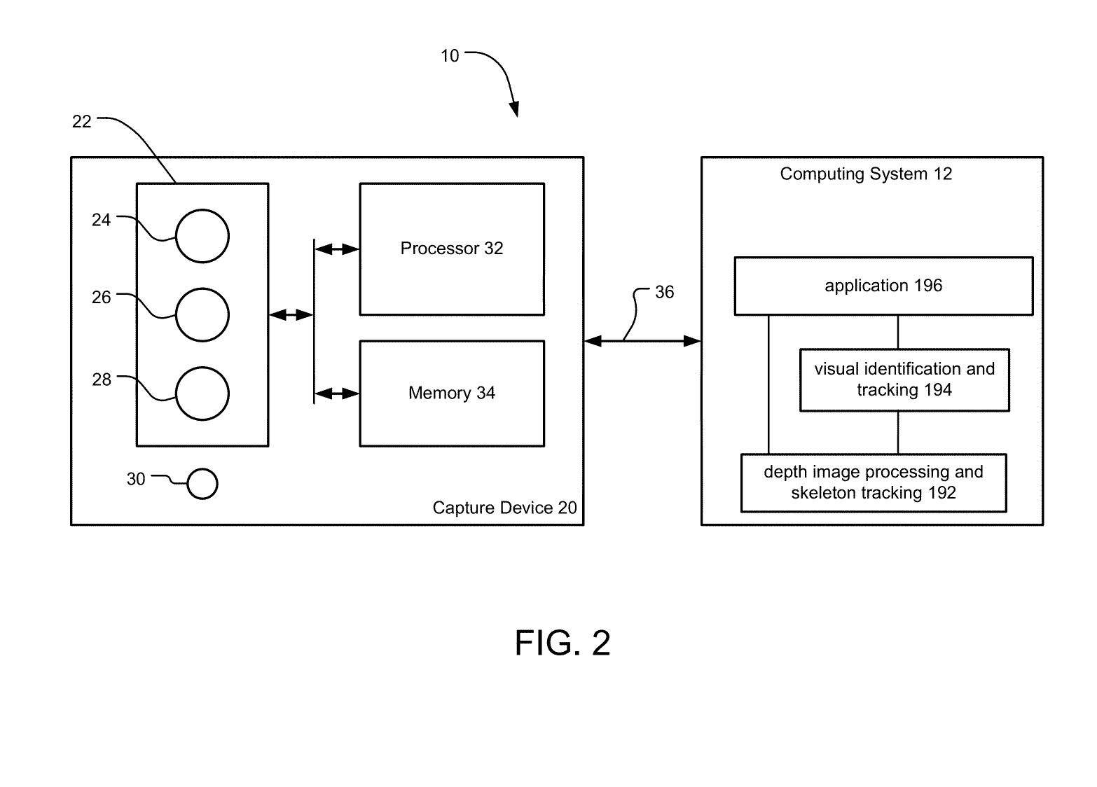

FIG. 2 illustrates an example embodiment of the capture device 20 that may be used in the tracking system 10. According to an example embodiment, the capture device 20 may be configured to capture video with depth information including a depth image that may include depth values via any suitable technique including, for example, time-of-flight, structured light, stereo image, or the like. According to one embodiment, the capture device 20 may organize the depth information into “Z layers,” or layers that may be perpendicular to a Z axis extending from the depth camera along its line of sight.

As shown in FIG. 2, the capture device 20 may include an image capture component 22. According to an example embodiment, the image capture component 22 may be a depth camera that may capture a depth image of a scene. The depth image may include a two-dimensional (2-D) pixel area of the captured scene where each pixel in the 2-D pixel area may represent a depth value such as a distance in, for example, centimeters, millimeters, or the like of an object in the captured scene from the camera.

As shown in FIG. 2, according to an example embodiment, the image capture component 22 may include an infra-red (IR) light component 24, a three-dimensional (3-D) camera 26, and an RGB camera 28 that may be used to capture the depth image of a scene. For example, in time-of-flight analysis, the IR light component 24 of the capture device 20 may emit an infrared light onto the scene and may then use sensors (not shown) to detect the backscattered light from the surface of one or more targets and objects in the scene using, for example, the 3-D camera 26 and/or the RGB camera 28. In some embodiments, pulsed infrared light may be used such that the time between an outgoing light pulse and a corresponding incoming light pulse may be measured and used to determine a physical distance from the capture device 20 to a particular location on the targets or objects in the scene. Additionally, in other example embodiments, the phase of the outgoing light wave may be compared to the phase of the incoming light wave to determine a phase shift. The phase shift may then be used to determine a physical distance from the capture device to a particular location on the targets or objects.

According to another example embodiment, time-of-flight analysis may be used to indirectly determine a physical distance from the capture device 20 to a particular location on the targets or objects by analyzing the intensity of the reflected beam of light over time via various techniques including, for example, shuttered light pulse imaging.

In another example embodiment, the capture device 20 may use a structured light to capture depth information. In such an analysis, patterned light (i.e., light displayed as a known pattern such as grid pattern, a stripe pattern, or different pattern) may be projected onto the scene via, for example, the IR light component 24. Upon striking the surface of one or more targets or objects in the scene, the pattern may become deformed in response. Such a deformation of the pattern may be captured by, for example, the 3-D camera 26 and/or the RGB camera 28 (and/or other sensor) and may then be analyzed to determine a physical distance from the capture device to a particular location on the targets or objects. In some implementations, the IR Light component 24 is displaced from the cameras 24 and 26 so triangulation can be used to determined distance from cameras 24 and 26. In some implementations, the capture device 20 will include a dedicated IR sensor to sense the IR light, or a sensor with an IR filter.

According to another embodiment, the capture device 20 may include two or more physically separated cameras that may view a scene from different angles to obtain visual stereo data that may be resolved to generate depth information. Other types of depth image sensors can also be used to create a depth image.

The capture device 20 may further include a microphone 30. The microphone 30 may include a transducer or sensor that may receive and convert sound into an electrical signal. According to one embodiment, the microphone 30 may be used to reduce feedback between the capture device 20 and the computing system 12 in the target recognition, analysis, and tracking system 10. Additionally, the microphone 30 may be used to receive audio signals that may also be provided by the user to control applications such as game applications, non-game applications, or the like that may be executed by the computing system 12.

In an example embodiment, the capture device 20 may further include a processor 32 that may be in communication with the image capture component 22. The processor 32 may include a standardized processor, a specialized processor, a microprocessor, or the like that may execute instructions including, for example, instructions for receiving a depth image, generating the appropriate data format (e.g., frame) and transmitting the data to computing system 12.

The capture device 20 may further include a memory component 34 that may store the instructions that are executed by processor 32, images or frames of images captured by the 3-D camera and/or RGB camera, or any other suitable information, images, or the like. According to an example embodiment, the memory component 34 may include random access memory (RAM), read only memory (ROM), cache, flash memory, a hard disk, or any other suitable storage component. As shown in FIG. 2, in one embodiment, memory component 34 may be a separate component in communication with the image capture component 22 and the processor 32. According to another embodiment, the memory component 34 may be integrated into processor 32 and/or the image capture component 22.

As shown in FIG. 2, capture device 20 may be in communication with the computing system 12 via a communication link 36. The communication link 36 may be a wired connection including, for example, a USB connection, a Firewire connection, an Ethernet cable connection, or the like and/or a wireless connection such as a wireless 802.11b, g, a, or n connection. According to one embodiment, the computing system 12 may provide a clock to the capture device 20 that may be used to determine when to capture, for example, a scene via the communication link 36. Additionally, the capture device 20 provides the depth information and visual (e.g., RGB) images captured by, for example, the 3-D camera 26 and/or the RGB camera 28 to the computing system 12 via the communication link 36. In one embodiment, the depth images and visual images are transmitted at 30 frames per second. The computing system 12 may then use the model, depth information, and captured images to, for example, control an application such as a game or word processor and/or animate an avatar or on-screen character.

Computing system 12 includes depth image processing and skeleton tracking 192, visual identification and tracking module 194 and application 196. Depth image processing and skeleton tracking 192 uses the depth images to track motion of objects, such as the user and other objects. To assist in the tracking of the objects, depth image processing and skeleton tracking 192 uses a gestures library and structure data to track skeletons. The structure data includes structural information about objects that may be tracked. For example, a skeletal model of a human may be stored to help understand movements of the user and recognize body parts. Structural information about inanimate objects may also be stored to help recognize those objects and help understand movement. The gestures library may include a collection of gesture filters, each comprising information concerning a gesture that may be performed by the skeletal model (as the user moves). The data captured by the cameras 26, 28 and the capture device 20 in the form of the skeletal model and movements associated with it may be compared to the gesture filters in the gesture library to identify when a user (as represented by the skeletal model) has performed one or more gestures. Those gestures may be associated with various controls of an application. Visual images from capture device 20 can also be used to assist in the tracking.

Visual identification and tracking module 194 is in communication with depth image processing and skeleton tracking 192, and application 196. Visual identification and tracking module 194 visually identifies whether a person who has entered a field of view of the system is a player who has been previously interacting with the system, as described below. Visual identification and tracking module 194 will report that information to application 196.

Application 196 can be a video game, productivity application, etc. Application 196 may be any of the mini-guide application, jump bar application, smart view application and/or prediction application described in greater detail hereinafter. Application 196 may further be an application for accessing content from one or more Web servers via a network such as the Internet. As one example, application 196 may be an application available from the ESPN® sports broadcasting service. Other examples are contemplated. In one embodiment, depth image processing and skeleton tracking 192 will report to application 196 an identification of each object detected and the location of the object for each frame. Application 196 will use that information to update the position or movement of an avatar or other images in the display.

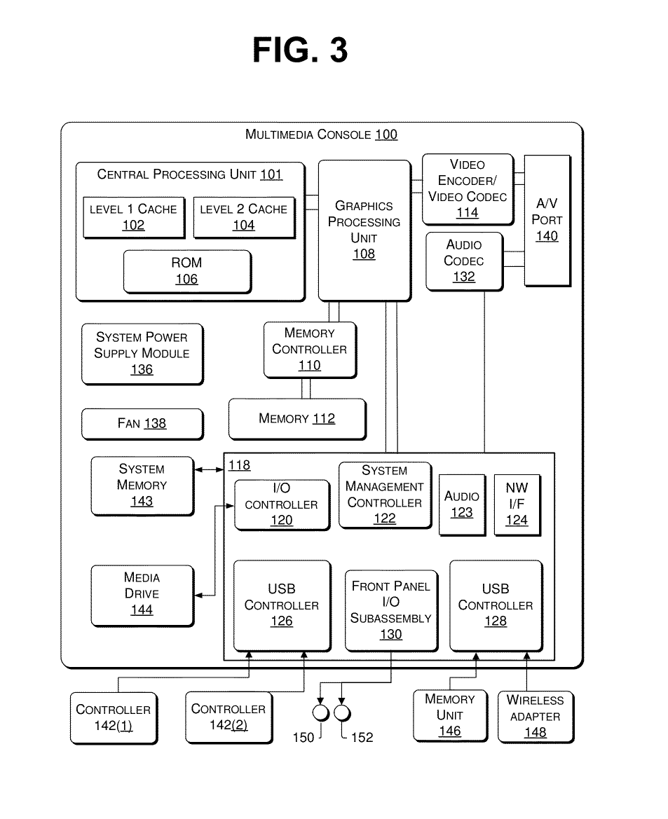

FIG. 3 illustrates an example embodiment of a computing system that may be the computing system 12 shown in FIGS. 1A-2 used to track motion and/or animate (or otherwise update) an avatar or other on-screen object displayed by an application. The computing system such as the computing system 12 described above with respect to FIGS. 1A-2 may be a multimedia console 100, such as a gaming console. As shown in FIG. 3, the multimedia console 100 has a central processing unit (CPU) 101 having a level 1 cache 102, a level 2 cache 104, and a flash ROM (Read Only Memory) 106. The level 1 cache 102 and a level 2 cache 104 temporarily store data and hence reduce the number of memory access cycles, thereby improving processing speed and throughput. The CPU 101 may be provided having more than one core, and thus, additional level 1 and level 2 caches 102 and 104. The flash ROM 106 may store executable code that is loaded during an initial phase of a boot process when the multimedia console 100 is powered on.

A graphics processing unit (GPU) 108 and a video encoder/video codec (coder/decoder) 114 form a video processing pipeline for high speed and high resolution graphics processing. Data is carried from the graphics processing unit 108 to the video encoder/video codec 114 via a bus. The video processing pipeline outputs data to an A/V (audio/video) port 140 for transmission to a television or other display. A memory controller 110 is connected to the GPU 108 to facilitate processor access to various types of memory 112, such as, but not limited to, a RAM (Random Access Memory).

The multimedia console 100 includes an I/O controller 120, a system management controller 122, an audio processing unit 123, a network interface 124, a first USB host controller 126, a second USB controller 128 and a front panel I/O subassembly 130 that are preferably implemented on a module 118. The USB controllers 126 and 128 serve as hosts for peripheral controllers 142(1)-142(2), a wireless adapter 148, and an external memory device 146 (e.g., flash memory, external CD/DVD ROM drive, removable media, etc.). The network interface 124 and/or wireless adapter 148 provide access to a network (e.g., the Internet, home network, etc.) and may be any of a wide variety of various wired or wireless adapter components including an Ethernet card, a modem, a Bluetooth module, a cable modem, and the like.

System memory 143 is provided to store application data that is loaded during the boot process. A media drive 144 is provided and may comprise a DVD/CD drive, Blu-Ray drive, hard disk drive, or other removable media drive, etc. The media drive 144 may be internal or external to the multimedia console 100. Application data may be accessed via the media drive 144 for execution, playback, etc. by the multimedia console 100. The media drive 144 is connected to the I/O controller 120 via a bus, such as a Serial ATA bus or other high speed connection (e.g., IEEE 1394).

The system management controller 122 provides a variety of service functions related to assuring availability of the multimedia console 100. The audio processing unit 123 and an audio codec 132 form a corresponding audio processing pipeline with high fidelity and stereo processing. Audio data is carried between the audio processing unit 123 and the audio codec 132 via a communication link. The audio processing pipeline outputs data to the A/V port 140 for reproduction by an external audio player or device having audio capabilities.

The front panel I/O subassembly 130 supports the functionality of the power button 150 and the eject button 152, as well as any LEDs (light emitting diodes) or other indicators exposed on the outer surface of the multimedia console 100. A system power supply module 136 provides power to the components of the multimedia console 100. A fan 138 cools the circuitry within the multimedia console 100.

The CPU 101, GPU 108, memory controller 110, and various other components within the multimedia console 100 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 100 is powered on, application data may be loaded from the system memory 143 into memory 112 and/or caches 102, 104 and executed on the CPU 101. The application may present a graphical user interface that provides a consistent user experience when navigating to different media types available on the multimedia console 100. In operation, applications and/or other media contained within the media drive 144 may be launched or played from the media drive 144 to provide additional functionalities to the multimedia console 100.

The multimedia console 100 may be operated as a standalone system by simply connecting the system to a television or other display. In this standalone mode, the multimedia console 100 allows one or more users to interact with the system, watch movies, or listen to music. However, with the integration of broadband connectivity made available through the network interface 124 or the wireless adapter 148, the multimedia console 100 may further be operated as a participant in a larger network community.

When the multimedia console 100 is powered ON, a set amount of hardware resources are reserved for system use by the multimedia console operating system. These resources may include a reservation of memory (e.g., 16 MB), CPU and GPU cycles (e.g., 5%), networking bandwidth (e.g., 8 kbs), etc. Because these resources are reserved at system boot time, the reserved resources do not exist from the application's view.

In particular, the memory reservation preferably is large enough to contain the launch kernel, concurrent system applications and drivers. The CPU reservation is preferably constant such that if the reserved CPU usage is not used by the system applications, an idle thread will consume any unused cycles.

With regard to the GPU reservation, lightweight messages generated by the system applications (e.g., pop ups) are displayed by using a GPU interrupt to schedule code to render popup into an overlay. The amount of memory needed for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV resynch is eliminated.

After the multimedia console 100 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 101 at predetermined times and intervals in order to provide a consistent system resource view to the application. The scheduling is to minimize cache disruption for the gaming application running on the console.

When a concurrent system application uses audio, audio processing is scheduled asynchronously to the gaming application due to time sensitivity. A multimedia console application manager (described below) controls the gaming application audio level (e.g., mute, attenuate) when system applications are active.

Input devices (e.g., controllers 142(1) and 142(2)) are shared by gaming applications and system applications. The input devices are not reserved resources, but are to be switched between system applications and the gaming application such that each will have a focus of the device. The application manager preferably controls the switching of input stream, without knowledge the gaming application's knowledge and a driver maintains state information regarding focus switches. The cameras 26, 28 and capture device 20 may define additional input devices for the console 100 via USB controller 126 or other interface.

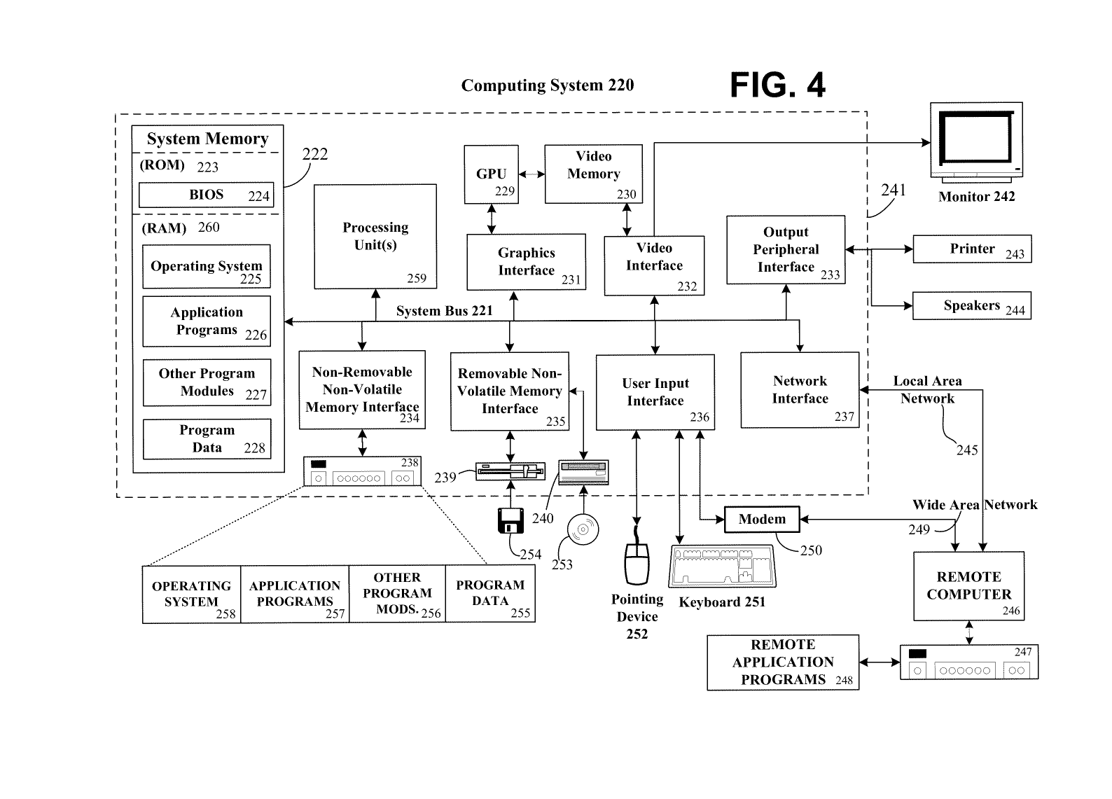

FIG. 4 illustrates another example embodiment of a computing system 220 that may be used to implement the computing system 12 shown in FIGS. 1A-2 used to track motion and/or animate (or otherwise update) an avatar or other on-screen object displayed by an application. The computing system 220 is only one example of a suitable computing system and is not intended to suggest any limitation as to the scope of use or functionality of the presently disclosed subject matter. Neither should the computing system 220 be interpreted as having any dependency or requirement relating to any one or combination of components illustrated in the exemplary operating system 220. In some embodiments the various depicted computing elements may include circuitry configured to instantiate specific aspects of the present disclosure. For example, the term circuitry used in the disclosure can include specialized hardware components configured to perform function(s) by firmware or switches. In other examples embodiments the term circuitry can include a general purpose processing unit, memory, etc., configured by software instructions that embody logic operable to perform function(s). In example embodiments where circuitry includes a combination of hardware and software, an implementer may write source code embodying logic and the source code can be compiled into machine readable code that can be processed by the general purpose processing unit. Since one skilled in the art can appreciate that the state of the art has evolved to a point where there is little difference between hardware, software, or a combination of hardware/software, the selection of hardware versus software to effectuate specific functions is a design choice left to an implementer. More specifically, one of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer.

Computing system 220 comprises a computer 241, which typically includes a variety of computer readable media. Computer readable media can be any available media that can be accessed by computer 241 and includes both volatile and nonvolatile media, removable and non-removable media. The system memory 222 includes computer storage media in the form of volatile and/or nonvolatile memory such as read only memory (ROM) 223 and random access memory (RAM) 260. A basic input/output system 224 (BIOS), containing the basic routines that help to transfer information between elements within computer 241, such as during start-up, is typically stored in ROM 223. RAM 260 typically contains data and/or program modules that are immediately accessible to and/or presently being operated on by processing unit 259. By way of example, and not limitation, FIG. 4 illustrates operating system 225, application programs 226, other program modules 227, and program data 228.

The computer 241 may also include other removable/non-removable, volatile/nonvolatile computer storage media. By way of example only, FIG. 4 illustrates a hard disk drive 238 that reads from or writes to non-removable, nonvolatile magnetic media, a magnetic disk drive 239 that reads from or writes to a removable, nonvolatile magnetic disk 254, and an optical disk drive 240 that reads from or writes to a removable, nonvolatile optical disk 253 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 238 is typically connected to the system bus 221 through an non-removable memory interface such as interface 234, and magnetic disk drive 239 and optical disk drive 240 are typically connected to the system bus 221 by a removable memory interface, such as interface 235.

The drives and their associated computer storage media discussed above and illustrated in FIG. 4, provide storage of computer readable instructions, data structures, program modules and other data for the computer 241. In FIG. 4, for example, hard disk drive 238 is illustrated as storing operating system 258, application programs 257, other program modules 256, and program data 255. Note that these components can either be the same as or different from operating system 225, application programs 226, other program modules 227, and program data 228. Operating system 258, application programs 257, other program modules 256, and program data 255 are given different numbers here to illustrate that, at a minimum, they are different copies. A user may enter commands and information into the computer 241 through input devices such as a keyboard 251 and pointing device 252, commonly referred to as a mouse, trackball or touch pad. Other input devices (not shown) may include a microphone, joystick, game pad, satellite dish, scanner, or the like. These and other input devices are often connected to the processing unit 259 through a user input interface 236 that is coupled to the system bus, but may be connected by other interface and bus structures, such as a parallel port, game port or a universal serial bus (USB). The cameras 26, 28 and capture device 20 may define additional input devices for the console 100 that connect via user input interface 236. A monitor 242 or other type of display device is also connected to the system bus 221 via an interface, such as a video interface 232. In addition to the monitor, computers may also include other peripheral output devices such as speakers 244 and printer 243, which may be connected through a output peripheral interface 233. Capture Device 20 may connect to computing system 220 via output peripheral interface 233, network interface 237, or other interface.

The computer 241 may operate in a networked environment using logical connections to one or more remote computers, such as a remote computer 246. The remote computer 246 may be a personal computer, a server, a router, a network PC, a peer device or other common network node, and typically includes many or all of the elements described above relative to the computer 241, although a memory storage device 247 has been illustrated in FIG. 4. The logical connections depicted include a local area network (LAN) 245 and a wide area network (WAN) 249, but may also include other networks. Such networking environments are commonplace in offices, enterprise-wide computer networks, intranets and the Internet.

When used in a LAN networking environment, the computer 241 is connected to the LAN 245 through a network interface or adapter 237. When used in a WAN networking environment, the computer 241 typically includes a modem 250 or other means for establishing communications over the WAN 249, such as the Internet. The modem 250, which may be internal or external, may be connected to the system bus 221 via the user input interface 236, or other appropriate mechanism. In a networked environment, program modules depicted relative to the computer 241, or portions thereof, may be stored in the remote memory storage device. By way of example, and not limitation, FIG. 4 illustrates application programs 248 as residing on memory device 247. It will be appreciated that the network connections shown are exemplary and other means of establishing a communications link between the computers may be used.

As explained above, capture device 20 provides RGB images (or visual images in other formats or color spaces) and depth images to computing system 12. The depth image may be a plurality of observed pixels where each observed pixel has an observed depth value. For example, the depth image may include a two-dimensional (2-D) pixel area of the captured scene where each pixel in the 2-D pixel area may have a depth value such as distance of an object in the captured scene from the capture device.

The system will use the RGB images and depth images to track a player's movements. An example of tracking can be found in U.S. patent application Ser. No. 12/603,437, “Pose Tracking Pipeline,” filed on Oct. 21, 2009, incorporated herein by reference in its entirety. In one embodiment of tracking a skeleton using depth image is provided in U.S. patent application Ser. No. 12/603,437, “Pose Tracking Pipeline” filed on Oct. 21, 2009, Craig, et al. (hereinafter referred to as the '437 Application), incorporated herein by reference in its entirety. Other methods for tracking can also be used. Once the system determines the motions the player is making, the system will use those detected motions to control a video game or other application. For example, a player's motions can be used to control an avatar and/or object in a video game.

While playing a video game or interacting with an application, a person (or user) may leave the field of view of the system. For example, the person may walk out of the room or become occluded. Subsequently, the person may reenter the field of view of the system. For example, the person may walk back into the room or is no longer occluded. When the person enters the field of view of the system, the system will automatically identify that the person was playing the game (or otherwise interacting with the application) and map that person to the player who had been interacting with the game. In this manner, the person can re-take control of that person's avatar or otherwise resume interacting with the game/application.

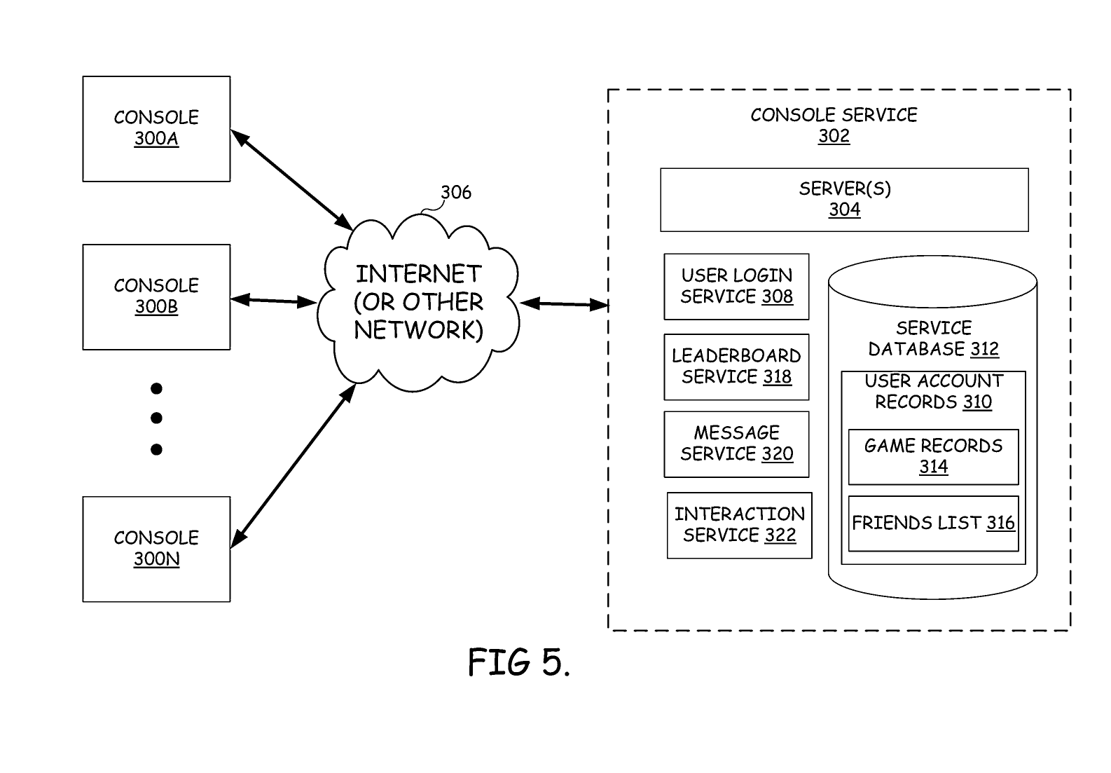

FIG. 5 provides a block diagram of multiple consoles 300A-300N networked with a console service 302 having one or more servers 304 through a network 306. In one embodiment, network 306 comprises the Internet, though other networks such as LAN or WAN are contemplated. Each console 300A-N may be any of a variety of client devices including for example a desktop computer, laptop tablet, smart phone or a variety of other computing devices.

Server(s) 304 include a communication component capable of receiving information from and transmitting information to consoles 300A-N and provide a collection of services that applications running on consoles 300A-N may invoke and utilize. For example, upon launching an application 196 on a console 300A-N, console service 302 may access and serve a variety of content to the console 300A-N via the interaction service 322 (explained below). This content may be stored in a service database 312, or this content may come from a third-party service, in conjunction with the interaction service 322.

Consoles 300A-N may also invoke user login service 308, which is used to authenticate a user on consoles 300A-N. During login, login service 308 obtains a gamer tag (a unique identifier associated with the user) and a password from the user as well as a console identifier that uniquely identifies the console that the user is using and a network path to the console. The gamer tag and password are authenticated by comparing them to user records 310 in a database 312, which may be located on the same server as user login service 308 or may be distributed on a different server or a collection of different servers. Once authenticated, user login service 308 stores the console identifier and the network path in user records 310 so that messages and information may be sent to the console.

User records 310 can include additional information about the user such as game records 314 and friends list 316. Game records 314 include information for a user identified by a gamer tag and can include statistics for a particular game, achievements acquired for a particular game and/or other game specific information as desired.

Friends list 316 includes an indication of friends of a user that are also connected to or otherwise have user account records with console service 302. The term “friend” as used herein can broadly refer to a relationship between a user and another gamer, where the user has requested that the other gamer consent to be added to the user's friends list, and the other gamer has accepted. This may be referred to as a two-way acceptance. A two-way friend acceptance may also be created where another gamer requests the user be added to the other gamer's friends list and the user accepts. At this point, the other gamer may also be added to the user's friends list. While friends will typically result from a two-way acceptance, it is conceivable that another gamer be added to a user's friends list, and be considered a “friend,” where the user has designated another gamer as a friend regardless of whether the other gamer accepts. It is also conceivable that another gamer will be added to a user's friends list, and be considered a “friend,” where the other user has requested to be added to the user's friends list, or where the user has requested to be added to the other gamer's friends list, regardless of whether the user or other gamer accepts in either case.

Friends list 316 can be used to create a sense of community of users of console service 302. Users can select other users to be added to their friends list 316 and view information about their friends such as game performance, current online status, friends list, etc.

User records 310 also include additional information about the user including games that have been downloaded by the user and licensing packages that have been issued for those downloaded games, including the permissions associated with each licensing package. Portions of user records 310 can be stored on an individual console, in database 312 or on both. If an individual console retains game records 314 and/or friends list 316, this information can be provided to console service 302 through network 306. Additionally, the console has the ability to display information associated with game records 314 and/or friends list 316 without having a connection to console service 302.

Server(s) 304 also include a mail message service 320 which permits one console, such as console 300A, to send a message to another console, such as console 300B. The message service 320 is known, the ability to compose and send messages from a console of a user is known, and the ability to receive and open messages at a console of a recipient is known. Mail messages can include emails, text messages, voice messages, attachments and specialized in-text messages known as invites, in which a user playing the game on one console invites a user on another console to play in the same game while using network 306 to pass gaming data between the two consoles so that the two users are playing from the same session of the game. Friends list 316 can also be used in conjunction with message service 320.

Interaction service 322, in communication with multiple consoles (e.g., 300A, 300B, . . . , 300N) via the Internet or other network(s), provides the interactive service discussed herein in cooperation with the respective local consoles. In some embodiments, interaction service 322 is a video or still content providing service that provides live video of sporting events (or other types of events), replays (or other pre-stored video), and/or statistics about an event (or other data about the event).

### Mini-Guide

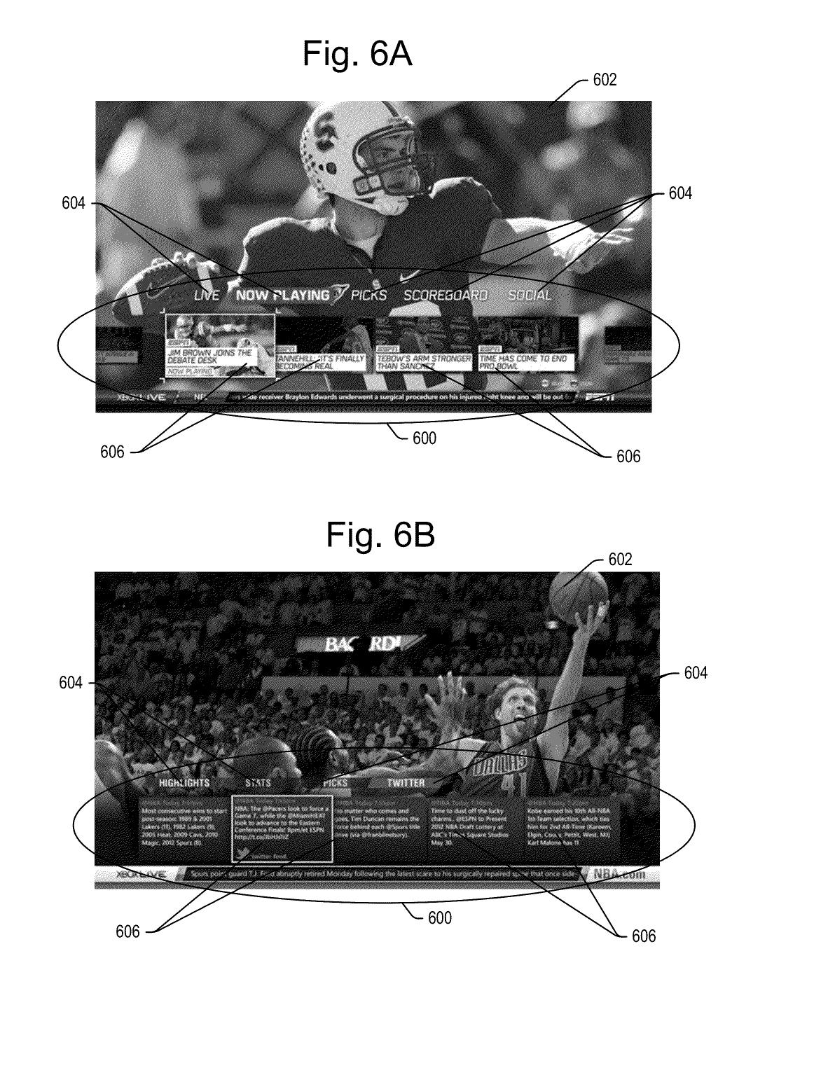

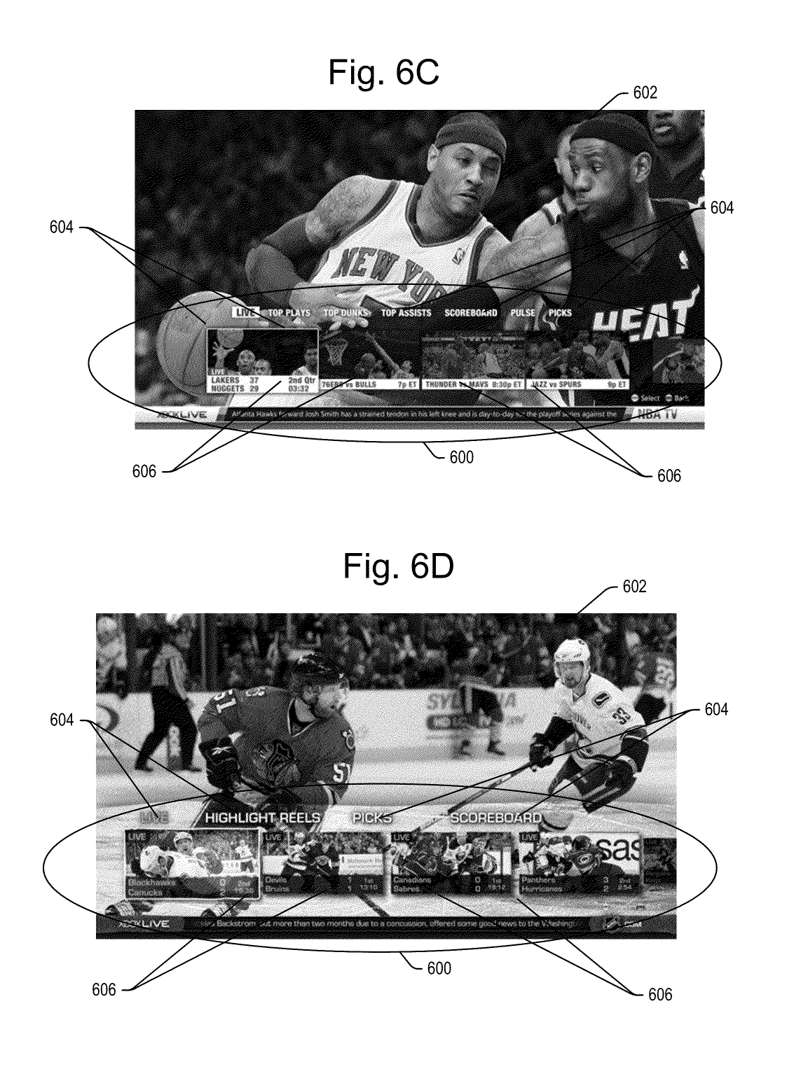

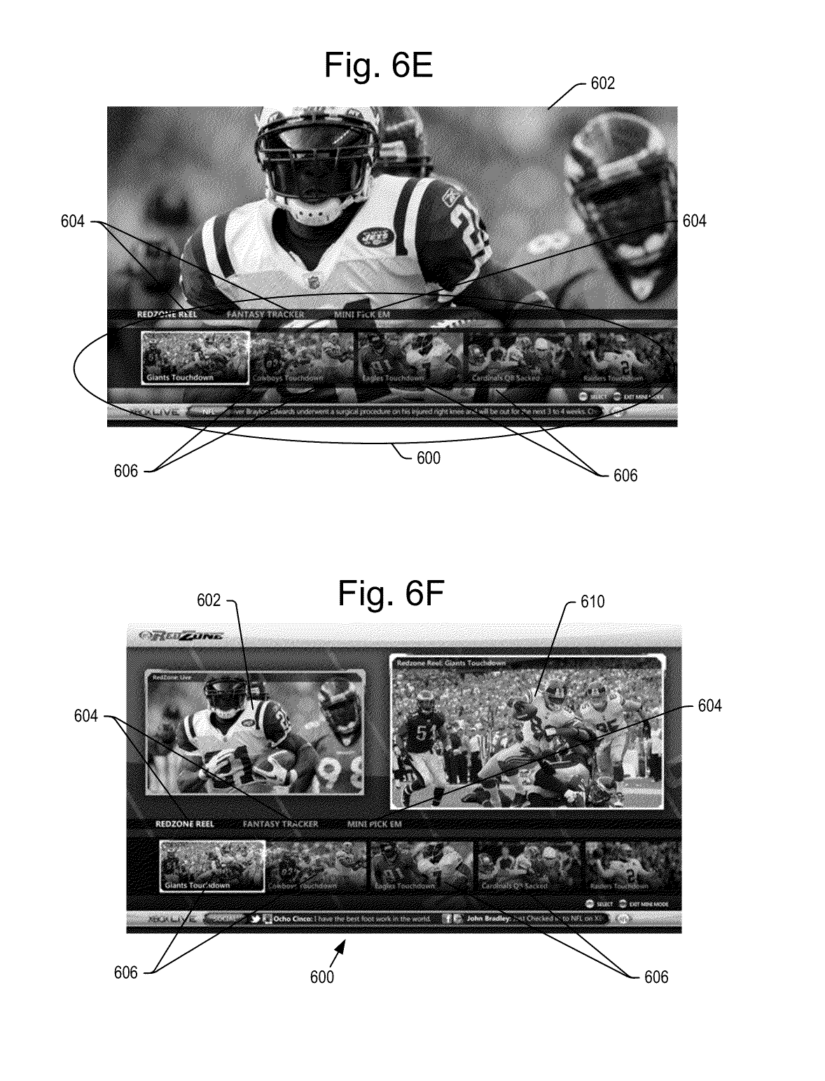

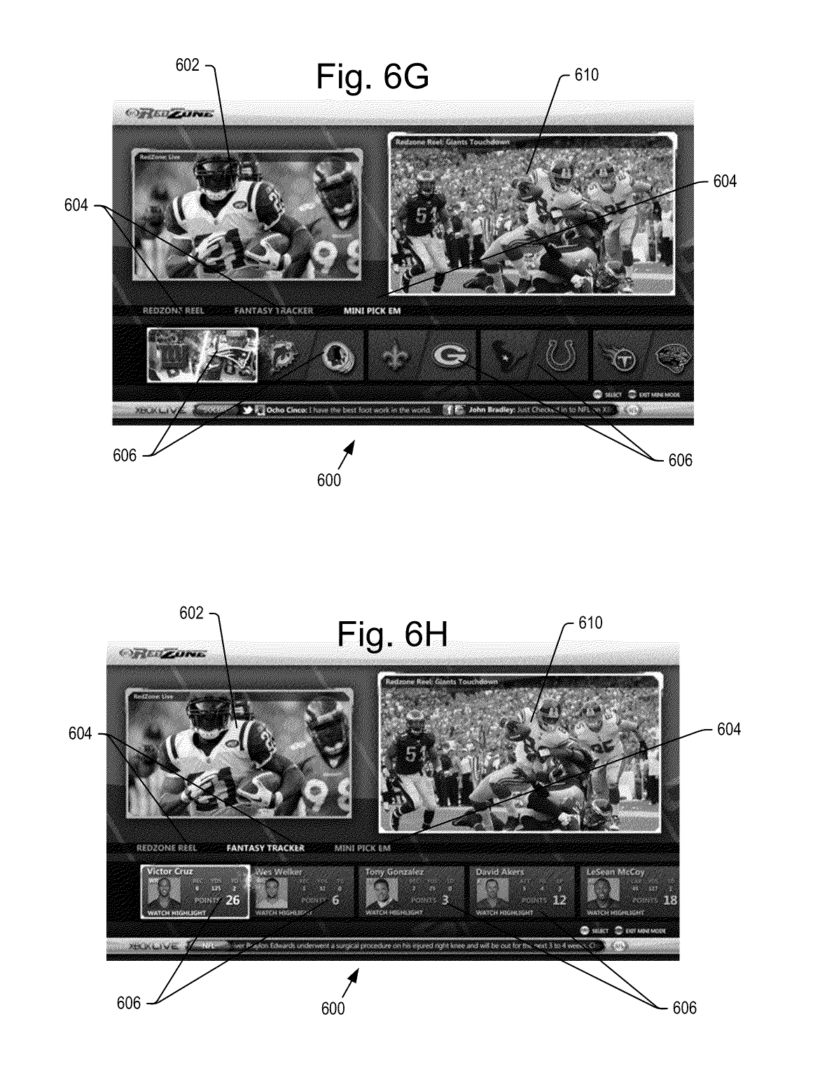

FIGS. 6A-6H depict various embodiments of a mini-guide 600 for interacting with a video content providing service, such as service 302 or another service. The mini-guide 600 provides video viewers with easy access to a select list of content, including videos and sports (or other types of) data, while continuing to watch their currently playing videos.

When the mini-guide application is activated from a console 300A-N, the mini-guide 600 appears on a display of the console 300A-N. In embodiment, the mini-guide may appear near the bottom of the screen, as shown in FIGS. 6A-6H, but it may appear at the top, the sides or in other locations in further embodiments. The mini-guide 600 may be displayed on top of a background video content 602, also referred to herein as a “now playing” video content. The background video(s) can either allow the mini-guide 600 to partially obscure the video. Alternatively, the background video can temporarily minimize. The size and location of the mini-guide may be chosen to be as unobtrusive over most sports videos as possible while still providing enough space for an attractive presentation. In one example, a majority of the background video is still visible when the mini-guide 600 is displayed. This majority may be between 55% and 90% of the background video, though it may be a smaller or larger percentage in further embodiments.

At the top of the mini-guide 600 is a set of categories, or “twists,” 604 which allow viewers to select the category of content they are interested in exploring. The exact twists 604 listed depends on both the content available to the viewer (e.g., the Live twist would not be listed for those viewers without meaningful access to Live content) and the nature of the video currently being viewed (e.g., a Game Stats twist may not be available when watching a game for which Stats are not provided). For example, in FIG. 6G there are three twists: Redzone Reel, Fantasy Tracker and Mini Pick 'Em.

Below the twists is a list of content items 606, populated according to the rules of the currently chosen twist 604. For example, if the Live twist is chosen (see FIG. 6C), the list will contain the Live videos currently available for viewing. If the Scoreboard is chosen, the list will contain the games covered by the service that are currently in progress or completed recently. The list of content may be displayed as items in graphical windows, each including streaming video, still images and/or up-to-date data so users can get a quick view of the most significant information for each item within the mini-guide itself. Some of the items from the lists are shown in FIGS. 6A-6H. A user may scroll the items left or right to view additional items.

Items in the list can also be actionable where appropriate. Actioning on a video (e.g., selecting the item through the user interface) will bring that video up for viewing or set a reminder for viewing it when it becomes available, while actioning on a player's statistics could present more detailed info for that player. Some items may not be actionable, for example where an item relates to a video which will be recorded at a later time (e.g., the item is a sporting event that takes place at a later time). An item may also not be actionable where a user does not have the permission needed to view the content of the item.

The action upon selecting an item may be appropriate to the current viewing experience as well. For example, if the user is watching a live game in full screen and actions on a highlight as in FIG. 6E, the highlight will come up in Split Screen as show in FIG. 6F. However, in examples, if the user is watching a highlight in full screen and selects another highlight, then the original highlight will simply be replaced.

When viewers switch between twists, the mini-guide remembers which item was selected at that time in the list, with the viewer being returned to that item (if still available) the next time that twist is selected. Likewise, when the mini-guide closes, it remembers which twist it was on, with the viewer being returned to that twist the next time the mini-guide is opened.

The mini-guide provides an easy way to access content a user is not currently viewing. The mini-guide can provide a variety of content, across a variety of channels having different types of content, in a convenient list. For example, content on, football, tennis, hockey, live sports highlights and content from other channels may be merged together in a single convenient list. The twists 604 may be customizable, by the interaction service 322 of the console service 302 and/or by a user of a console 300A-N. The form factor of the item windows may also be selected to allow a user to easily identify content from different items, without significantly obscuring the playing now content.

In FIG. 6A, a user is viewing items 606 under the now playing twist 604. The user has highlighted a particular item 606, which may then be enlarged to view as split screen with the background video content 602, or it may replace the background video content 602. In FIG. 6B, the user has selected a twist 604 including twitter posts, which are then displayed as items 606. In FIGS. 6C and 6D, a user has selected the live twist 604. Live events may then be displayed as items 606. The items 606 in this example may also include a score of the live event. In FIG. 6D, a user has selected the Redzone Reel twist 604, and selected a particular item 606. As shown in FIG. 6F, the selected item may then be enlarged and viewed in a split screen window 610 with the now playing content 602. FIG. 6G illustrates the split screen including content 602 and 610 as in FIG. 6F, where the user has further selected a new twist 604 bringing up options from the prediction application (described hereinafter). In FIG. 6G, the user is presented with an option to make picks from scheduled football games. In FIG. 6H, the split screen is shown as in FIG. 6F, where the user has selected the fantasy tracker twist 604 displaying items relating to fantasy football statistics for various players.

Some features of the mini-guide include:

Expandable, pageable, twist/tab based layout: Twists can be added as new categories of content are needed or twists can be taken away (by the interactive service 322 and/or the user). Content lists can be grouped into pages as needed to facilitate scrolling through any length of list.

Occupies a small portion (for example bottom third) of the screen: obscures small portion of the broadcast, the least problematic area of most broadcasts.

Contextual twists and content lists: The list of twists and their content is relevant to the actual content being viewed. The mini-guide application is aware of the content the user is viewing. There may be associations and rules generated and stored in the service database 312 of the console service 302 relating certain content with twists and lists under those twists. For example, when a user is viewing a recording of an event that took place earlier, the final score of that event may be omitted from the list under a live or other twist. A wide variety of other associations and rules may be provided so that the twists and lists under the twists are selected and/or customized based at least in part on the background content.

Contextual actions within the content tiles (content windows): The actions users can take on each content tile are appropriate to the content being viewed.

Saves your place: The mini-guide application remembers users most recently selected twist and most recently selected item within each twist so users can return to the mini-guide where they left off.

Stream video to the content tiles: Content tiles can display streaming video.

Activity/Notification on twists: As alerts and real-time data come into the application, they may be added to the mini-guide and the user is pointed to the mini-guide to view them. Thus, if the mini-guide 600 is not being displayed, a user may receive an alert to open and/or display the mini-guide as it receives new updates. Twists having new updated content may have a graphic displayed in association with the twist indicating that content under the twist has been updated since it was last viewed by the user.

Convenient Activation: The mini-guide is activated and controlled via a game controller, a keyboard, voice command and/or gestures (using the sensor(s) discussed above).

### Jump Bar

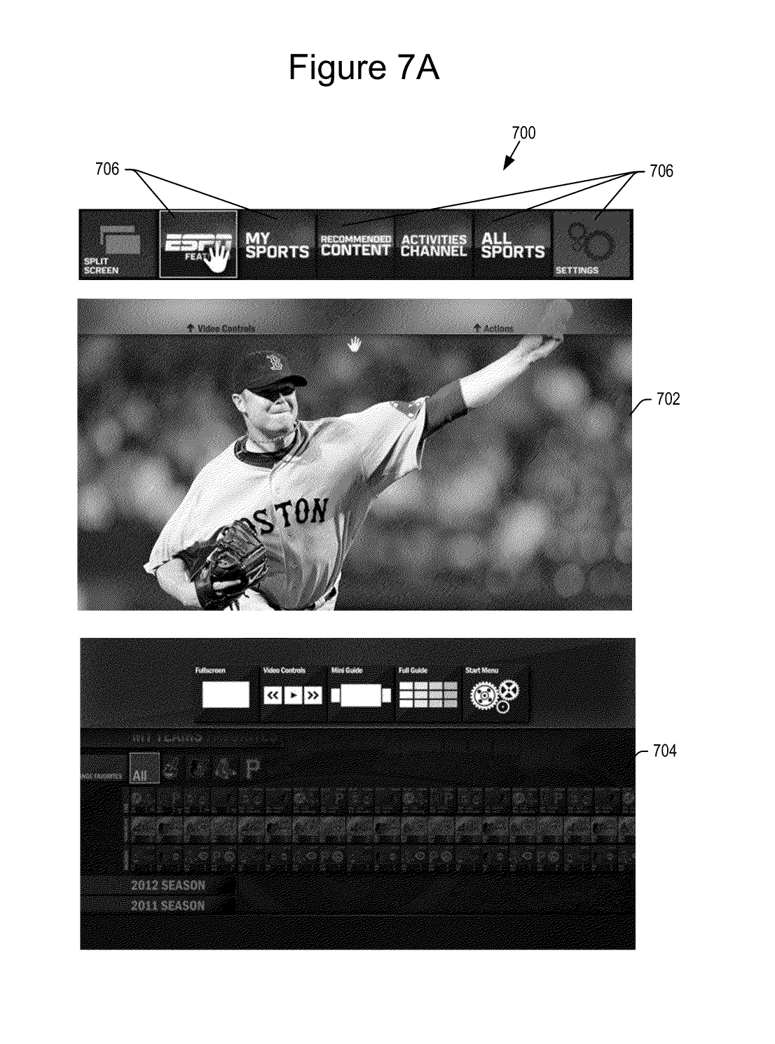

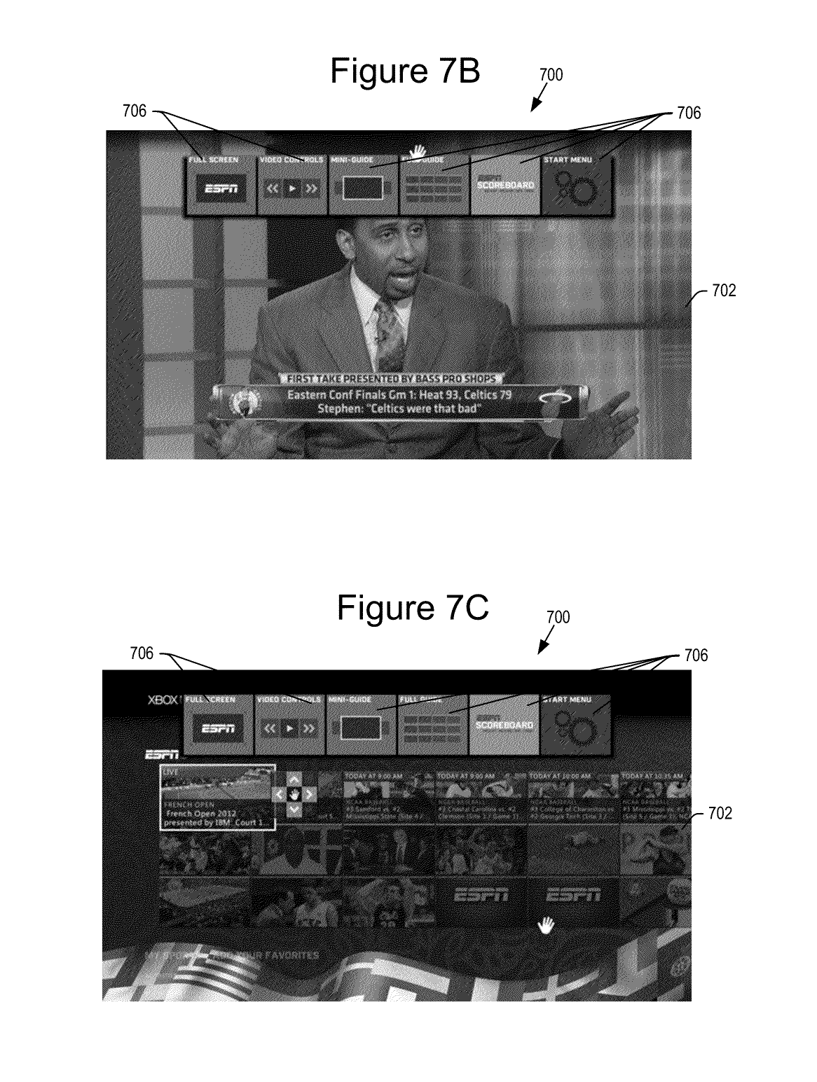

FIGS. 7A-7C depict various embodiments of a jump bar 700 for navigating to different features and content provided by Interaction service 322. FIG. 7A shows the jump bar 700 used in a split screen mode including two windows 702, 704 with content being displayed to a user. FIGS. 7B & 7C shows the jump bar 700 in a full screen mode each including a window 702 with content being displayed to the user.

Upon launching the jump bar application from a console 300A-N, the jump bar 700 maps common application navigation tasks to tiles, or windows, 706 in a simple dropdown pane, accessible via an input device such as a mouse or game controller, or via a NUI system such as voice command or gestures (using sensor system described above). By default, the jump bar is hidden, but can be summoned to appear by game controller, voice command or gestures. The jump bar exists primarily to map to a tile what would otherwise be a controller button press and secondarily to shortcut that might otherwise be accessed through cumbersome layers of gesture or controller menu navigation. To aid in quick option selection, tiles contain iconographic representations of identifiable pieces of interface, with clear titles.

Certain options might appear when the jump bar is summoned in a certain section of the app, but might not appear if pulling up the jump bar elsewhere. For instance, if no video is playing, the jump bar may dynamically choose not to display the full screen option.

Options may be selected by hovering with the gesture based “hand” cursor in a NUI system. The jump bar menu remains active after a selection is made for quick access to other options. If no action is taken, the jump bar may auto-hide itself.

Features include:

Flexible design—Application designers and the interactive service 322 can pin to the jump bar any variety of interface options or menu selections. One application's jump bar may have significantly different options than those of another application. A user may also customize the tiles in the jump bar 700 to include tiles

Contextual option display—The jump bar's options can be designed to appear or not appear based on navigational context or application state.

Instant access—The jump bar can be pulled up over any screen in the application, at any time, so the most powerful options are not more than a quick touch & hover, or click, away.

Touch to engage—when UI is engaged by normal means, the jump bar's indicator appears in an unobtrusive fashion (an arrow over the top of the screen), but selecting the jump bar operates by nothing more than a brief selection of the indicator.

“Shortcut” access to powerful application features—Multiple navigational steps are reduced to a single selection.

### Smart View

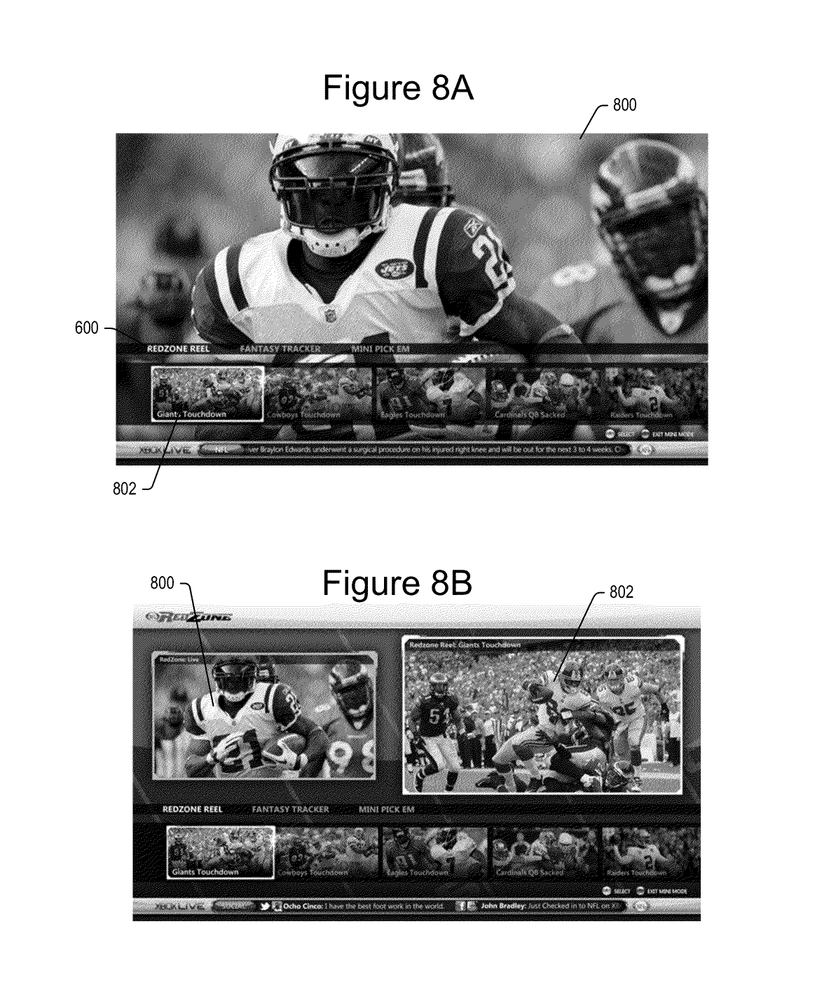

FIG. 8A shows one embodiment of a guide, such as mini-guide 600, for interacting with a video content providing service, with a first video content 800 being shown and a second video content 802 being selected. FIG. 8B shows a split screen mode, showing the original video content 800 and the second video content 802 sharing a screen (split screen) based on the smart view application described herein, after the second video is chosen using the guide of FIG. 8A.

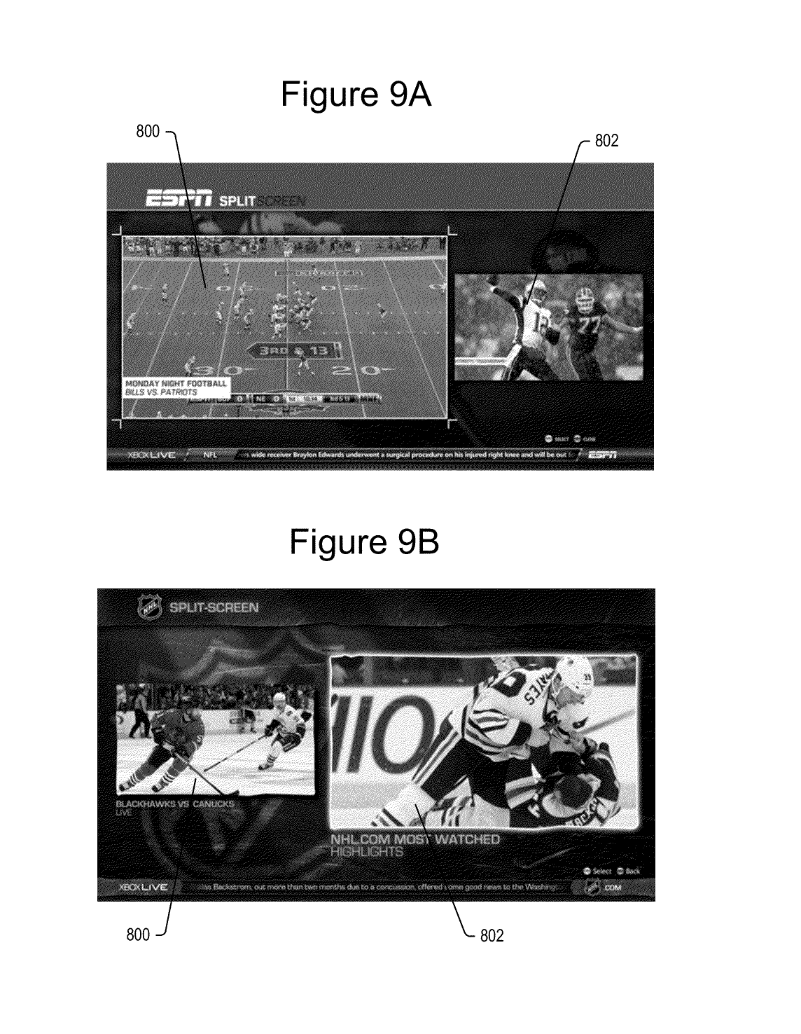

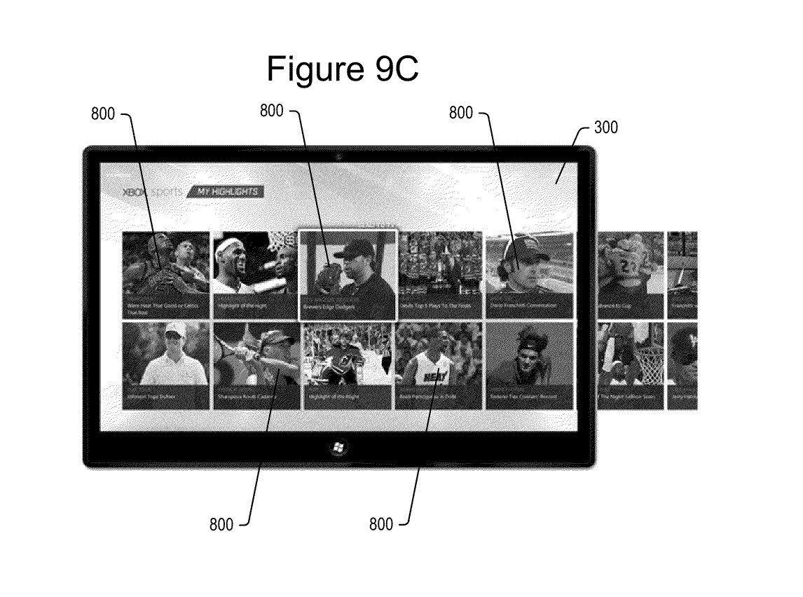

FIGS. 9A-C depict various embodiments for sharing a screen between sources of content, based on the smart view application described herein.

The smart view application intelligently and automatically determines the most appropriate viewing mode when new content is chosen for viewing, or as content finishes playing, so that users get the best possible viewing experience. Viewing mode as used herein refers to the arrangement of content on a display, and the relative sizing of different content on a display. It bases this determination on factors including the content that is already playing, the content being chosen, the way the content was chosen, users selecting the content and the device on which the content is being viewed. The result is that content plays in an intuitively understood place on the screen and users can take full advantage of more advanced viewing modes with minimal user-education efforts.

The smart view application includes a number of defined rules, stored for example in the service database 312, of how to display different content when multiple items of content are selected. In one of many possible examples, each type of content may receive a significance rating. A live event may receive a high significance rating, while a replay of an event may receive a lower significance rating. Other types of content such as highlight shows, game statistics, fantasy statistics, prediction application picks and content related to other events and aspects of the events may receive significance ratings. These ratings may be set or adjusted by the application developer, the console service 302 and/or by the user.

When showing two different contents split screen, the contents may be shown in the same size relative to each other, or one item of content may be showed larger, for example based on their respective significance ratings. Alternatively, the newly selected content may be displayed as being larger. As a further alternative, whichever content was most recently selected by the user may be shown as larger content. FIGS. 9A and 9B illustrate a split screen mode each including content 800 and 802 sized relative to each other by the smart screen application.

In one example, when a user is viewing a first content and selects a second content for viewing, whether to go split screen and the relative sizing of the first and second items of content may be determined by their respective significance ratings. In one example, where a new content has a lower significance rating than the original content, the new content may be brought up in split screen with the new content, and may be the same size or smaller than the original content. In one example, where the new content has a higher significance rating than the original content the new content may replace the original content so that the new content is shown in full screen. A variety of other rules may be developed and applied for determining how two or more viewed items of content may share the screen.

When viewers are watching a game in full screen, selecting a new highlight to watch, for example from the mini-guide 600, may automatically put the user into split screen, focused on the new highlight with the original game playing unfocused. Both the focused and unfocused videos may have the same clarity, but a video in focus may for example be brighter than a video not in focus, or there may be a highlight box around a video in focus. Moreover, audio may be played from the video in focus. When the highlight finishes, its video screen may automatically close and the user may be returned to full screen viewing of the original game.

The stored rules may also include qualifications for certain types of content or context. For example, if the user is watching a live content in full screen and chooses and other live content, they may be brought up in split screen. However, if the viewer is watching highlight content in full screen and selects another highlight content to view, the new highlight content may simply replace the old highlight in full screen.

In addition to the type of content and context, the smart view application may arrange content on a display based on how the content is selected. For example, it is known that one or more users may interact with multiple consoles 300A-N when viewing content. These devices may supplement each other in the viewing of content, for example through the use of Xbox Smartglass™ interactivity software.

With such applications, the viewer may be watching a game in full screen on the television and may select new content to play from a companion device, e.g., a touchscreen device, by “flinging” the new content toward the television. FIG. 9C illustrates a list of available content items 902 on a console device 300, which may be a tablet in this embodiment. A user may select a content item 902 from console device 300, and fling it to the television. Here, flinging is a gesture performed to bring up content from the tablet 300 on the television. Upon performing the flinging gesture, the television screen may switch to split screen.

Moreover, NUI systems are typically able to identify the position of users in a room. Thus, if the smart view application senses that the user on one side of the room flings content to the display, the new content may be displayed on a side of the screen nearest to that user. Alternatively, the NUI system may sense the direction in which the user performed the flinging gesture to place an item of content on the screen, for example as a vector from the user which intersects the screen at a certain location. The smart view application may then display new content at that location, split screen with the original content.

For more complicated viewing situations, with multiple users controlling the screen, specific areas of the screen can be assigned to different users so that its clear which user is controlling which content.

Features include:

Support for multiple viewing modes: smart view can put users into full screen, split screen, Picture in Picture and other multi-screen modes as needed.

Intelligent Viewing Mode Selection: smart view selects a viewing mode based on the type of content that is currently playing, the type of content being activated, the device or screen that content was activated on, and the exact method used to activate the content. Viewing mode changes can also be based on the remaining content after a video ends and its viewing screen closes.

Intelligently selected viewing screens: Using the sensor system described above (e.g., with depth camera), the position on screen for playing new content is based on the position in the room of the user selecting new content, the identity of the person making the selection, and/or the directional nature of the method of selection. For example, if the user is standing to the left of the screen, then the new content is displayed on the left side of the screen. The smart view application may also store user preferences, such as for example a user wishes to view content in split screen or full-screen, or that a user wishes content added to the screen to be displayed at a particular location.

### Prediction Application

The Prediction Application, running on the local console (or other computing device), is a prediction gaming experience across the a console service ecosystem such as Xbox Live (see FIG. 5) that allows players to quickly connect with friends and the community, engage deeper with their content, and better celebrate memorable moments while being rewarded for doing so. It leverages the existing behaviors around live content, the growing trends of synched, multi-device entertainment and gamification and creates a wholly integrated, interactive experience around linear content.

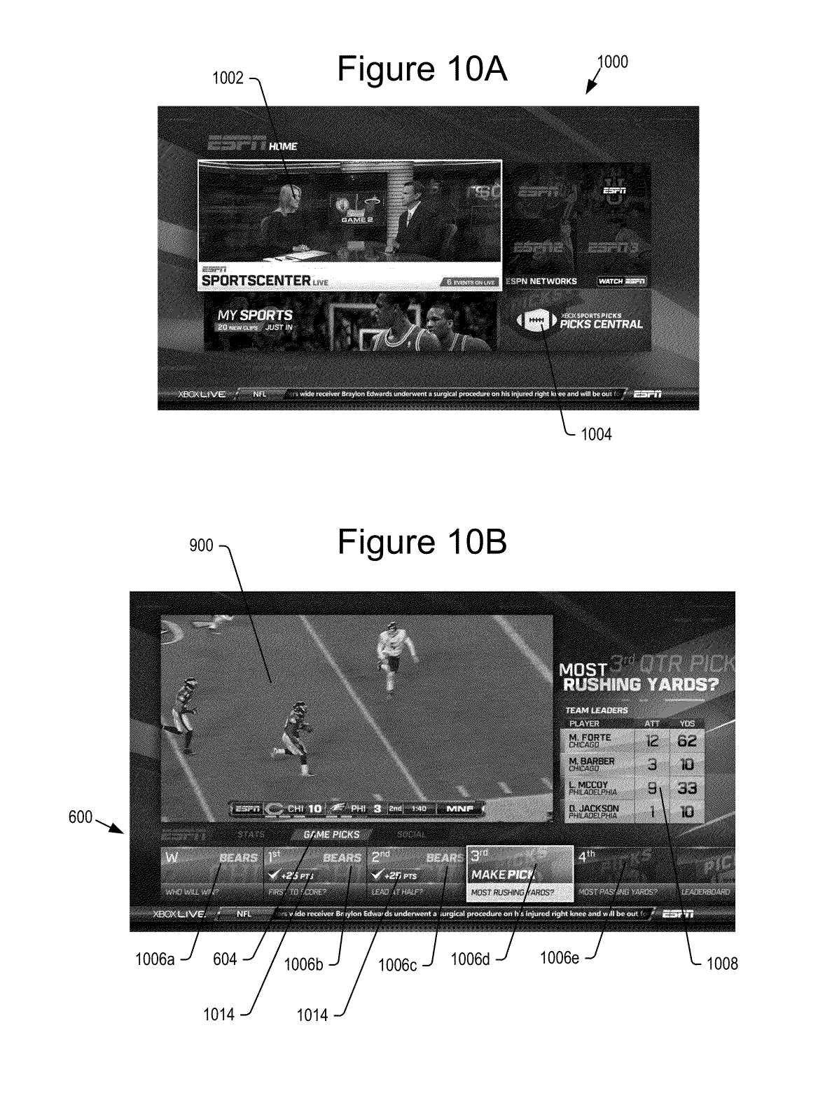

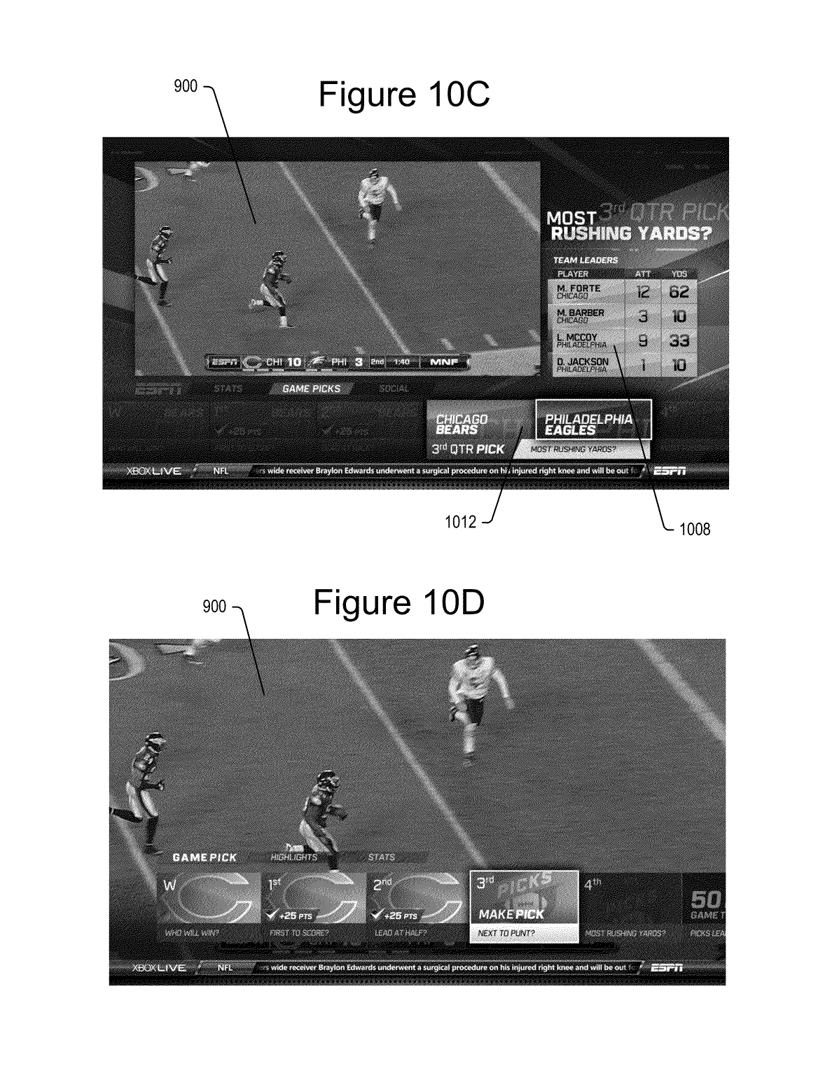

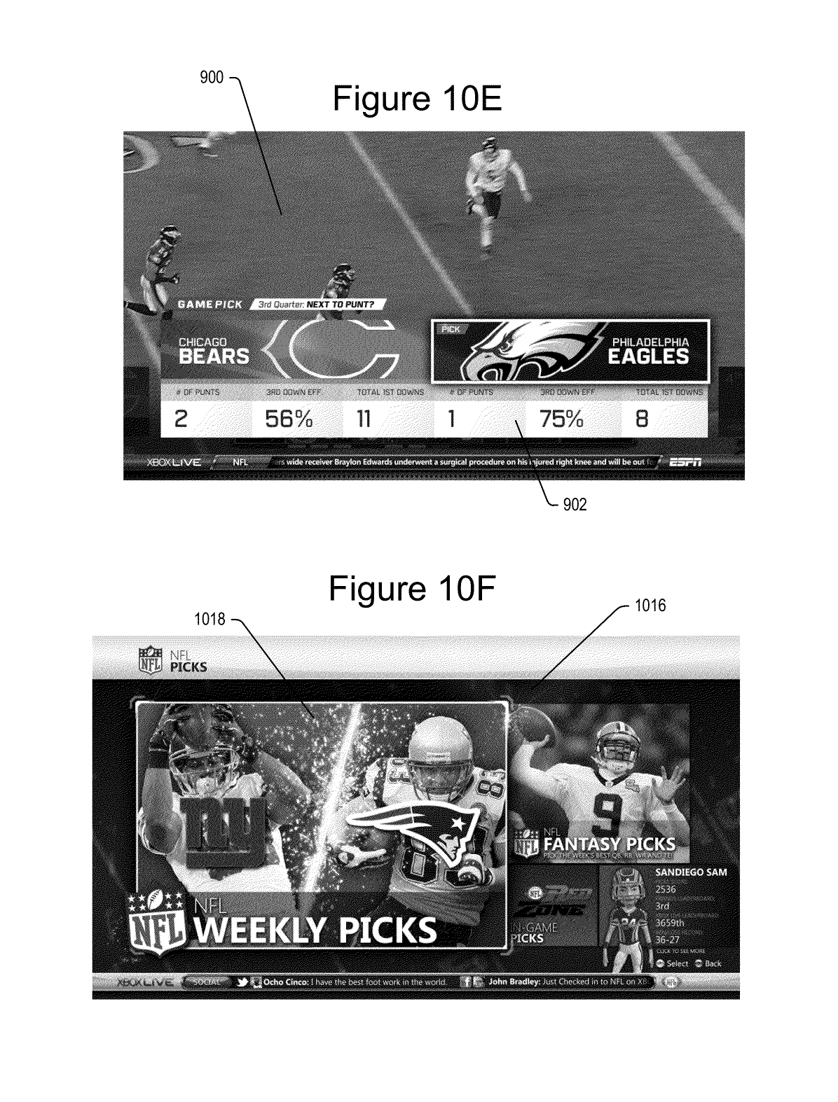

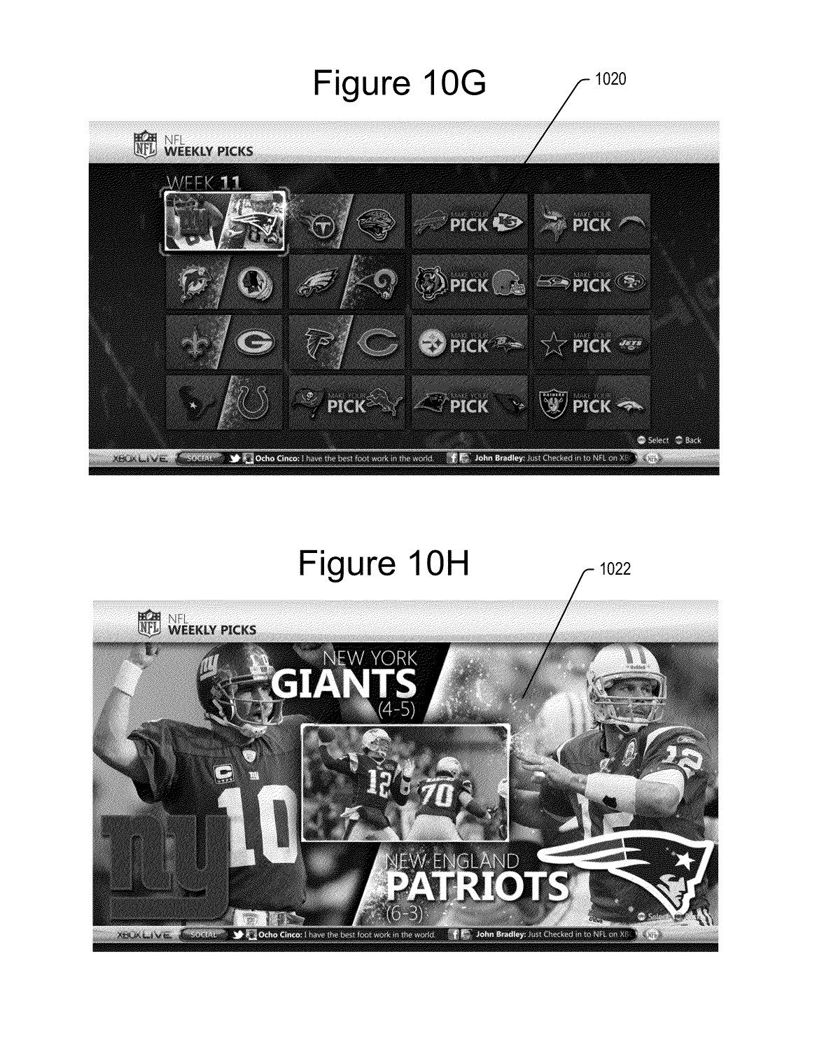

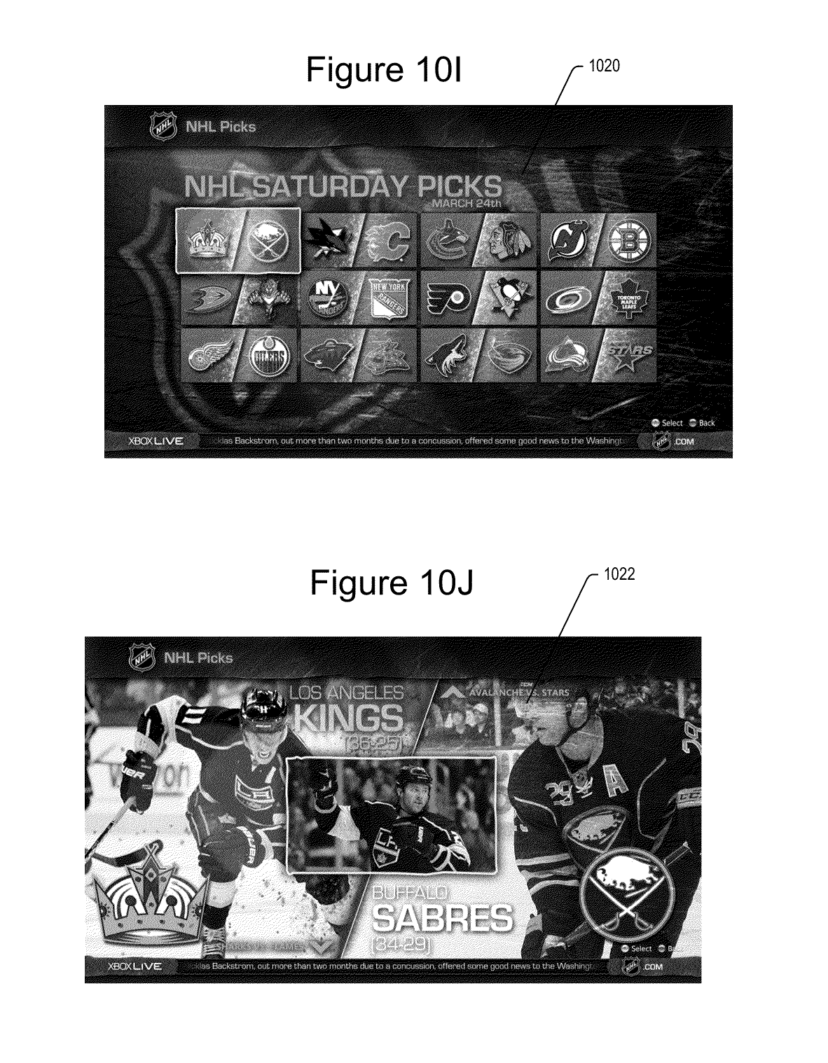

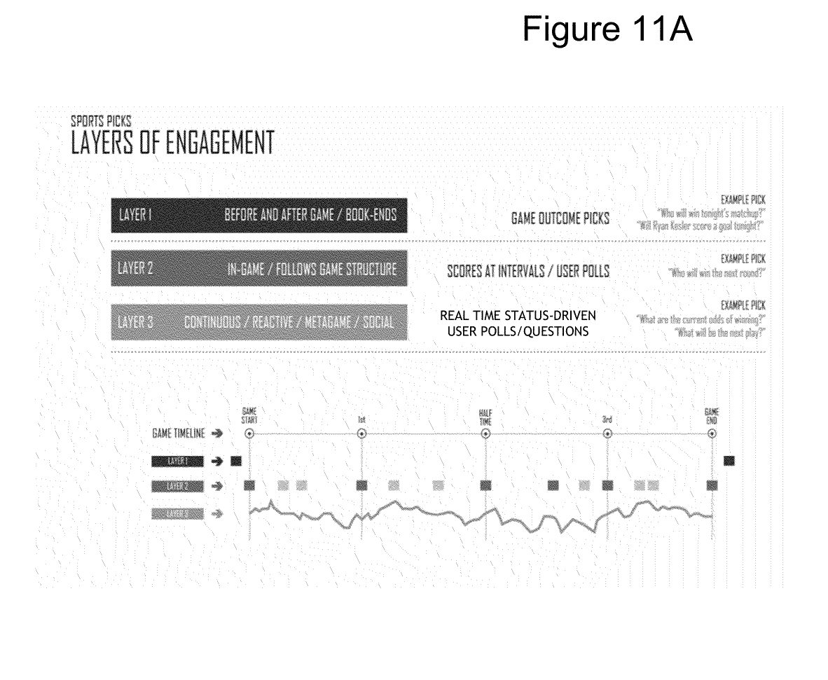

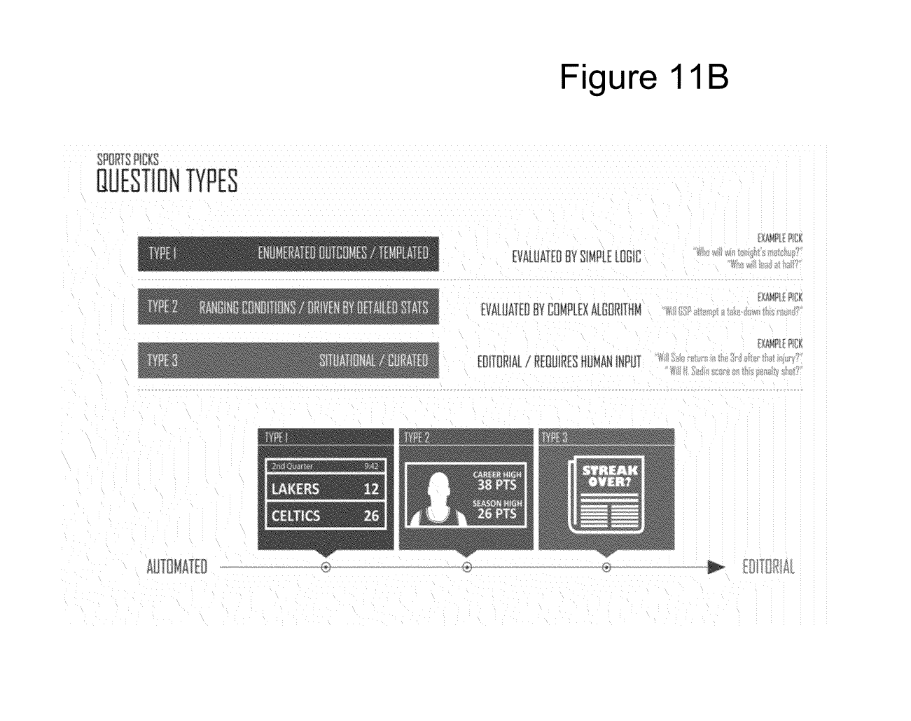

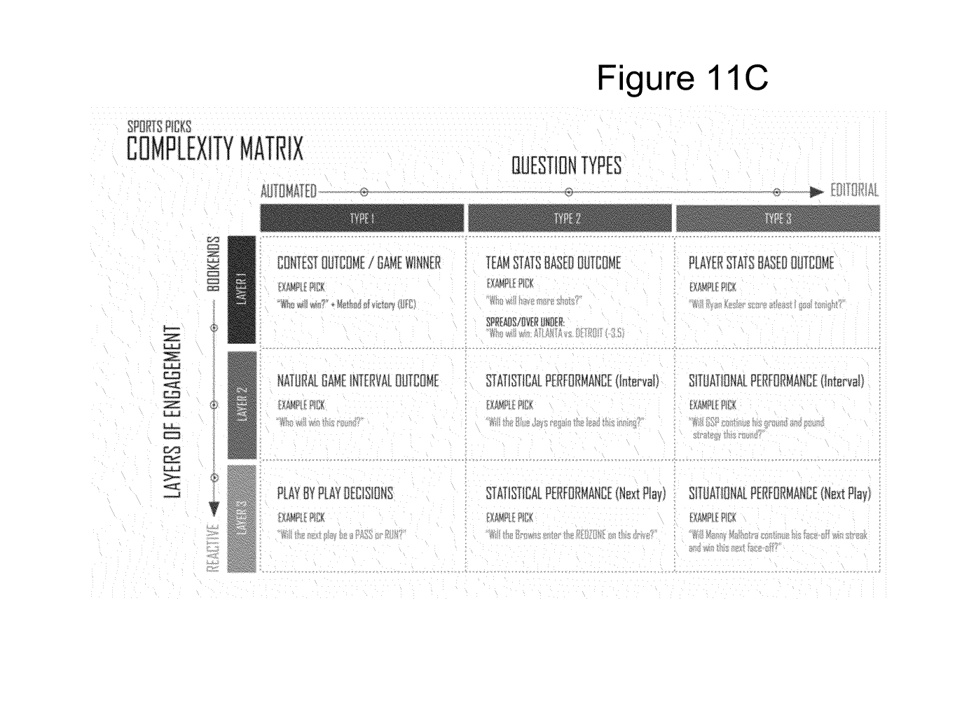

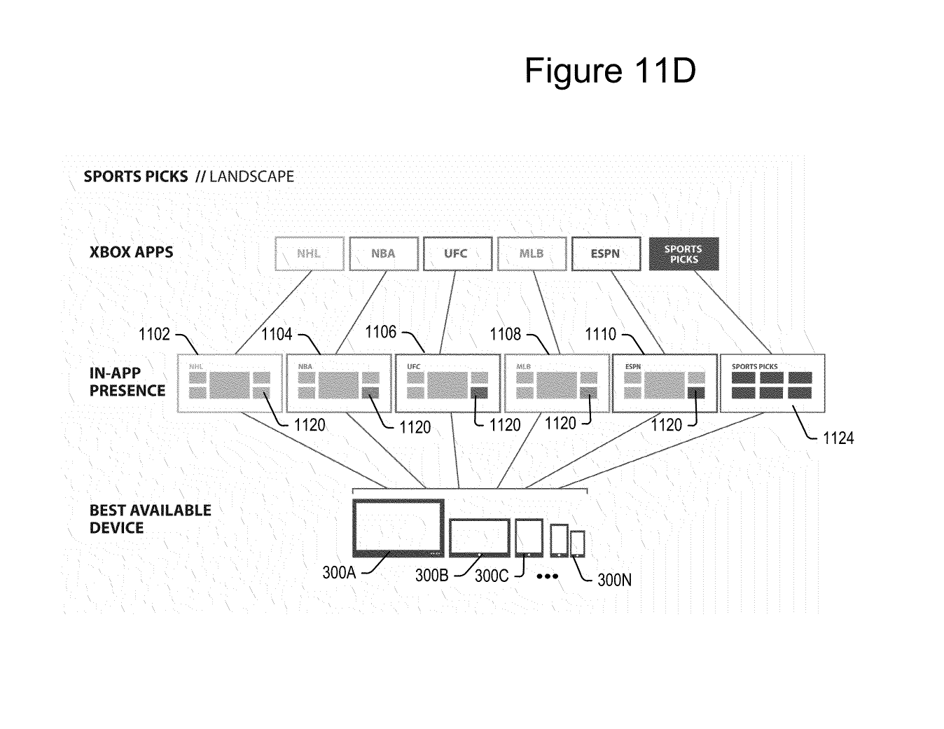

FIGS. 10A-J depict screen shots of a graphical user interface displayed on a monitor. These figures show the operation of the prediction application that allows users to predict events in real time during an event. FIGS. 11A-D describe details of the prediction application. The following description uses sporting events as an example, but it is understood that the prediction application may be used for a wide variety of other events to predict intermediate or final outcomes of those events. The prediction application accepts picks, which are predictions by a user as to the intermediate or ultimate aspects of an event such as a sporting event. The prediction application may also be used to receive polling picks, where the prediction application receives votes on an aspect of an event without there necessarily being a definitive correct or incorrect outcome. The picks, including polling picks, may be input by a user through interaction with the prediction application as shown in FIGS. 10A-J and as explained below.

In one aspect, the prediction application implements a game via a graphical user interface such as shown in FIGS. 10A-J that is played at times and on devices of the users' choosing. For example, as shown in FIG. 10A, a user may be presented with a graphical user interface 1000 including content 1002 and a picks window 1004. A user may access the prediction application by selecting the picks window 1004. The picks window 1004 can be accessed from graphical user interfaces including a variety of different content in further embodiments. In one such example shown below, a graphical user interface may be dedicated to the prediction application and may include a variety of different picks windows dedicated to different events.

Once a user has selected a pick window 1004, a user may be presented with a variety of different topics from which a user may select specific events on which they would like to make picks. Alternatively, game picks may be contextual. For example, where a user is viewing content 900, such as shown in FIG. 10B, the mini-guide 600 may include a twist 604 for game picks. When that twist is selected, game picks specific to the content being viewed may be displayed. In the example of FIG. 10B, the user is viewing a football game between the Chicago Bears and the Philadelphia Eagles. When the user selects the game picks twist 604, the user is presented with various picks windows 1006 from which the user may make picks relating specifically to the Bears/Eagles game.

In making picks, users may be asked, in real time, before or during a sporting event, to predict the final outcome, intermediate outcomes, statistics and other facets of the sporting event being simultaneously viewed and/or sporting events not being viewed. The picks windows 1006 provide opportunities for a user to make a pick as to a wide variety of aspects of the selected event. For example, in the example of FIG. 10B, the users may be given the option to select the ultimate winner of the contest (window 1006a). Users may also be given the option to predict various outcomes that are determined at intervals during the course of the game. For example, in window 1006b, a user is asked to predict which team will be the first to score. In window 1006c, the user is asked to predict which team will lead at the half. Windows 1006d and 1006e illustrate examples where a user is asked to make a prediction as to which player will have the most rushing yards and which player will have the most passing yards, respectively. A wide variety of other questions may be presented on which users may make predictions.

A user may select events on which to make predictions by selecting a particular window. For example, in FIG. 10B, a user is shown selecting window 1006d. Upon selecting that window, a new window 1008 is presented to the user with the rushing leaders from the respective teams in the game. A user may then pick a team, for example from a window 1012 as shown in FIG. 10C. In this example, the user has picked the Philadelphia Eagles, as indicated by that pick being highlighted. FIG. 10D illustrates an alternative question which could be posed to users: which team will be “next to punt?” The user's selection is shown in FIG. 10E.

Once the selection is made, that user's prediction may be displayed in the respective windows. For example, in response to the question “who will win” in window 1006a, the user has selected the Bears, as indicated in the window. In response to the question “first to score?” in window 1006b, the user has selected the Bears, and in response to the question “lead at the half?” in window 1006c, the user has again selected the Bears.

The illustration of FIG. 10B is taken at a time after the first half of football has expired, but before the end of the game. Therefore, the results to the questions asked in windows 1006b and 1006c are known, and it is known whether the user's predictions were correct or incorrect. The results of the questions posed in picks windows 1006a, 1006d and 1006e will remain unknown until the end of the game.

In the example shown in FIGS. 10B and 10C, the prediction application may present the questions in real time, at different times of the game. For example, the question in picks window 1006a may be presented before the game. The question in picks window 1006b may be presented at the start of the first quarter. The question in picks window 1006c may be presented at the start of the second quarter, etc. It is understood these questions may be asked at different times in further embodiments.

The prediction application may include one or more routines for collecting answers, determining whether answers are correct, allocating points to users for correct answers and storing point totals and user interactivity and trends. For example, the prediction application may reward players with pick points when they successfully make a prediction within the game. In the example of FIG. 10B, the user's predictions in picks windows 1006b and 1006c was correct. Accordingly, the use was awarded picks points as indicated by the graphics 1014. The number of picks points shown in by way of example only and may be smaller or larger in further examples. Pick points may be persistent and aggregated across multiple applications in the system (see FIG. 5) and may be tied into an achievements system and leaderboard, which data may be maintained for example in game records 314. The totals may be used for social interaction and competition, for example between friends or in the community in general. Friends may communicate with each other while making predictions via communications components of the system 10. The game may have a weekly reward/celebration cycle with daily engagement pulls/attractors through notifications and posts to social networks.

The prediction application aggregates, e.g., sports picks across the console service ecosystem and may also feature a pick of the day to focus community participation around a particular event. Some special events will have additional real time picks that are authored or editorialized in synch with the events. Players will receive bonus points for participating in these special picks events.

FIGS. 10F through 10J illustrate further examples and options available through the prediction application. FIG. 10F illustrates a user interface 1016 allowing users to make predictions in football games for the upcoming week by selecting a weekly picks window 1018. Upon selecting window 1018, the user may be presented with the graphical user interface 1020 as shown in FIG. 10G including the different games in the upcoming week. In the example of FIG. 10G, the user has selected the New York Giants/New England Patriots football game. Accordingly, the user is next presented with a graphical user interface 1022 as shown in FIG. 10H allowing a user to make picks with respect to that football game. FIGS. 10I and 10J illustrate a similar flow for making predictions for hockey games played on a given night.

Referring now to FIG. 11A, there may be different layers of engagement for the picks that a user may make. Layer 1 picks may relate to the ultimate outcome of the game, match or other event. Layer 1 picks may also relate to individual aspects of the event which will be determined once the event is over. The answers to layer 1 picks may have a finite number of answers, and may have a right and a wrong answer. Layer 2 picks may be similar to layer 1 picks, but are determined at different intervals before the conclusion of the event. A distinguishing feature of layer 3 picks is that they are context-based. That is, they are based on actions which occur during the event, and for example may not be conceived of prior to the event. Layer 3 picks may include polling picks which may not have a correct or incorrect answer.

Referring now to FIG. 11B, questions forming the basis of user picks may be broken down into 3 types. Type 1 questions may be those which have a finite number of enumerated outcomes, such as for example “who will win the match,” or “who will lead at the half?” Type 1 questions may be generated algorithmically by the prediction application. Type 2 questions take into consideration different conditions in the event, and ask whether or not something is going to happen at a given point in the event. They may be based on statistics from the event and a statistical likelihood that something will or will not happen. Type 2 questions may be generated algorithmically by the prediction application, taking into consideration conditions at the event. Type 3 questions are questions that require human input to generate. They are conceived by an operator, based on specific situations that occur in the event. FIG. 11C illustrates a complexity matrix of layers of engagement (layers 1-3) versus question types (types 1-3). Specific examples of questions appropriate to the levels and types are provided therein.

FIG. 11D illustrates five graphical user interfaces 1102, 1104, 1106, 1108 and 1110 related to five different channels or categories of content. Each of those graphical user interfaces may include a picks window 1120 allowing a user to make picks via the prediction application as described above for those respective categories. FIG. 11D also shows a sports pick graphical user interface 1124 which may be dedicated to sports picks, and may include options for making sports picks in the different channels or categories from user interfaces 1102-1110.

FIG. 11D also illustrates a variety of different consoles 300A-N. Is a feature of the present technology that the prediction application, as well as the mini-guide application, jump bar application and/or smart view application may be optimized for different types of consoles and may be seamlessly handed off between different types of consoles while maintaining state data and ease-of-use.

Some features include:

Aggregation of interactions across multiple sports and other applications (ESPN, MLB, NHL, NBA, UFC, etc.) on Xbox or other console service.

Messaging and Notification of Picks activity across sports and apps—e.g., while watching an MLB game within the MLB app players can get notification of a friend or community pick about the upcoming UFC fight.

Pacing or the Picks Cycle—every week there is a new set of Picks and a refresh of the Leaderboards. Special rewards (titles, achievements, bonus Pick Points) are given to top players each week in a number of categories (overall, per sport, etc.)

Featured Pick of the Day editorialization on Xbox game console or other console service.

Real time Picks synched with live events on Xbox or other console service—certain events like a featured NFL game could have quarterly picks based on live events as they unfold. A running back may be nearing 100 yards in rushing at the half and a question can be generated as a 3^{rd} quarter pick to ask if he is going to rush for more than 100 yards by the end of that quarter.

Diminishing points returns for real time picks—rewards/points decrease over time after each real time pick is revealed.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It is intended that the scope of the invention be defined by the claims appended hereto.

We claim:

1. A gaming apparatus, comprising:
an input system for inputting commands to the gaming apparatus; and
a processor for receiving commands from the input system and generating a graphical user interface, the processor implementing any combination of one or more of:
a mini-guide for displaying categories of content and lists of content associated with the categories via the graphical user interface, the content coming from a video or still content providing service, the mini-guide displaying the lists of content as a plurality of selectable graphical windows having still images or video content, input from the input system scrolling through the plurality of graphical windows of a list;
a prediction software application for receiving predictions via the input system and providing feedback when it is determined whether a prediction is correct or incorrect, and providing reward points when a prediction is correct, the prediction software application presenting questions on which predictions are received, the questions relating to an event depicted in a selected graphical window from the mini-guide; and
a smart screen application for arranging and sizing two or more items of content displayed on the graphical user interface based on a set of rules, the rules including positioning an item of content on a first side of the graphical user interface where the first item of content was generated from receipt of a command that is detected as coming from a location proximate the first side of the graphical user interface.

2. The gaming apparatus of claim 1, further comprising a jump bar including graphical windows for navigating to defined features and content provided by the video or still content providing service.

3. The gaming apparatus of claim 1, wherein selection of a graphical window displayed in the mini-guide displaying a third item of content depicted in the graphical window.

4. The gaming apparatus of claim 3, wherein the third item of content is replaces an item of content being displayed before selection of the graphical window.

5. The gaming apparatus of claim 3, wherein the third item of content is displayed split screen with an item of content being displayed before selection of the graphical window.

6. The gaming apparatus of claim 5, wherein the smart screen application determines a split screen arrangement and relative sizing of the third item of content and the item of content being displayed before selection of the graphical window.

7. The gaming apparatus of claim 1, wherein the categories in the mini-guide include sporting an events category including events displayed in live coverage, a predictions category for presenting predictions questions regarding sporting events, a scoreboard category for presenting scores from sporting events, and a social category for presenting interactive options with respect to social media and sports fantasy leagues.

8. The gaming apparatus of claim 1, wherein the input system comprises a natural user interface.

9. The gaming apparatus of claim 1, wherein the input system comprises a game controller.

10. A system, comprising:
an input system for inputting commands controlling content displayed on the gaming system;
a processor for receiving commands from the input system and generating a graphical user interface on a display, the processor implementing a prediction software application via the graphical user interface for presenting questions customized in real time to content the user is viewing, and for receiving predictions in response to the questions via the input system; and
a storage location for storing information regarding predictions received.

11. The system of claim 10, the prediction application providing feedback via the graphical user interface when it is determined whether a prediction is correct or incorrect, and providing reward points when a prediction is correct, the storage location storing a tally of rewards points for different users.

12. The system of claim 10, the prediction application presenting a graphical window superimposed over content being displayed, selection of the graphical window presenting the questions customized in real time to the content the user is viewing.

13. The system of claim 10, the prediction application presenting a graphical window superimposed over content being displayed, selection of the graphical window displaying a central predictions display on the graphical user interface, the central predictions display displaying a variety of upcoming sporting events from which a user may select a sporting event to make predictions.

14. The system of claim 10, the prediction application presenting questions relating to aspects of a sporting event which become known at the end of the sporting event.

15. The system of claim 10, the prediction application presenting questions relating to aspects of a sporting event which become known at intervals during the sporting event.

16. The system of claim 10, the prediction application generating first and second items of content, the processor further implementing a smart screen application for arranging and sizing of the first and second items of content via the graphical user interface.

17. A method of facilitating interaction with an audio/video presentation, comprising:
(a) displaying a graphical user interface including a display of a first item of video content;
(b) superimposing a mini-guide over the first item of content at a size and location allowing a majority of the first item of content to be viewed, the mini-guide displaying categories of content and lists of content associated with the categories via the graphical user interface, the categories being customized to the first item of content being displayed, and the lists of content being a plurality of selectable graphical windows having still images or video content;
(c) receiving a selection of a graphical window from the mini-guide; and
(d) displaying a second item of content from the graphical window selected in said step (c) on the graphical user interface.

18. The method of claim 17, further comprising the step of determining how and if to display the first and second items of content on the display by a set of rules contained in a smart view application.

19. The method of claim 17, further comprising presenting a plurality of questions and receiving predictions as to answers of those questions upon selection of a category in the mini-guide relating to predictions.

20. The method of claim 17, further comprising presenting a jump bar on the display upon receiving an indication to view the jump bar, the jump bar including graphical windows for navigating to defined features and additional content.
